(19) United States
(12) Patent Application Publication
(10) Pub. No.: US 2003/0078762 A1
(43) Pub. Date: Apr. 24, 2003

(54) Simulation system, method, program and record medium

(75) Inventors: Masayoshi Hashima, Kawasaki (JP); Yosuke Senta, Kawasaki (JP); Yuichi Sato, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/013,450

(22) Filed: Dec. 13, 2001

(30) Foreign Application Priority Data
Jul. 19, 2001 (JP) 2001-219188

(51) Int. Cl. G06F 17/50; G06G 7/62

(52) U.S. Cl. 703/13

(57) ABSTRACT

A virtual mechanism model simulation device constructs a virtual mechanism model of a mechanism device, and allows the model to run by performing simulating calculation based on the input data from a built-in software execution device. The virtual mechanism model simulation device comprises a first processing unit to make input/output to/from the built-in software execution device and execute mechanism operation of the virtual mechanism model, and a second processing unit to execute drawing processing of the virtual mechanism model using the free time of the first processing unit.

### BACKGROUND OF THE INVENTION

1. Field of the Invention

The present invention relates generally to a simulation system, method, program and a record medium, which allow a virtual mechanism model to run by simulation calculations, depending on the control input from a built-in software execution device, and more particularly to a simulation system, method, program and a record medium, which allow a virtual mechanism model to run, with a mechanism operation processing and a second processing being separated from each other.

2. Description of the Related Art

In developing and designing a mechanism device that performs three-dimensional motions with a motor as its driving source, for instance, a CD changer, MD changer, printer, etc., before making a prototype of the actual device, several steps have so far been required to be made, including steps of detailed design, release of drawing, and making arrangements for component parts, after a concept of the mechanism being formulated. At the same time, a control program, usually called built-in software, to embody a built-in software execution device for the mechanism device, used to be developed. In developing the control program, brief design, detailed design and further debugging used to be made while the manufactured machinery being controlled as a prototype. FIG. 1 shows an example of the conventional system, and in developing built-in software, a microcomputer, a built-in software execution device 200 comprising a control board mounting a microcomputer, and a mechanism device (actual mechanism machinery) 202 are prepared, and the built-in software execution device 200 is to be connected to the mechanism device 202 with a signal line, to execute input or output of motor signals to a motor or signals from a sensor. However, as the manufacture of the mechanism device is a time-consuming job, compared with the development of built-in software, there has so far been a problem that a connection test of developed software could not be made until a prototype of the mechanism device was completed. As a technology to solve this problem, as shown in FIG. 2, a simulation system has been proposed, in which, instead of the mechanism device, a virtual mechanism model simulation device 206 that constructs a virtual mechanism model on a computing machine is to be prepared, and to be connected to the built-in software execution device 200 through an interface unit 204, to progress the development of a control program with the virtual mechanism model regarded as the actual mechanism device.

However, on such a simulation system, against the command input from the built-in software execution device 200, at the built-in software execution device 206, drawing is executed while three-dimensional motion of the virtual mechanism model is computed, so, computation of the position/posture of component parts, the component parts of the virtual mechanism model, which means a processing concerning drawing, and drawing processing for display take a lot of time, thereby causing the model to be only able to move slowly, compared with the execution speed of the control program. So, it became necessary to insert synchronous signals and synchronous processing between the built-in software execution device 200 and the virtual mechanism model simulation device 206.

FIG. 3 shows a processing flowchart of the conventional system, with a synchronous processing inserted between the built-in software execution device 200 and the virtual mechanism model simulation device 206. The control program for the built-in software execution device 200 will output a synchronous signal Flag 1 to the simulation device at a step S1, and at a step S2, the program will wait for a synchronous signal Flag 2 from the virtual mechanism model simulation device 206. By doing so, the control program is designed to keep up with the slow move of the virtual mechanism model simulation device 206. When the control program receives the synchronous signal Flag 2 from the virtual mechanism model simulation device 206, it enters a sensor value at a step S3, and after processing a necessary event at a step S4, outputs a motor command value to the simulator at step S5, thus it repeats the processing. At a step S101, the virtual mechanism model simulation device 206 waits for the synchronous signal Flag 1 from the built-in software execution device 200, and when the device 206 receives the synchronous signal (Flag 1) after one processing cycle is ended at the control program, at a step S102, it enters a motor command value, and at a step S103, executes the mechanism operation of a three-dimensional motion for the command value input of the mechanism model, and at a step S104, it computes the position/posture of all the component parts making up the virtual mechanism model that moved for drawing. Continuously at a step S105, the device executes a three-dimensional drawing processing for display to display the virtual mechanism model on a monitor screen, and after outputting a sensor value at a step S106, the device eventually outputs the synchronous signal Flag 2 to the built-in software execution device at a step S107, to allow the control program for the built-in software execution device 200 to execute the next cycle. As described above, on the conventional system, by creating at the step S2, a synchronous signal wait state on the control program, in short, on built-in software of the built-in software execution device, the time scale is allowed to match with the simulation of the mechanism model that takes a lot of time in processing. However, on the conventional simulation system, the developer of built-in software has to do a troublesome work to add an additional process of synchronous wait of the simulation device to the control program. Also, as the processing concerning drawing for display takes a lot of time, the move of the mechanism model at the simulation device against the input of the motor command value sent from the built-in software execution device fails to be real time move in the actual control, thus failures have so far taken place that the command by the control program was not reflected on the mechanism model in real time.

### SUMMARY OF THE INVENTION

According to the present invention there is provided a simulation system, method, program and a record medium that are able to move a virtual mechanism model in real time by simulation computing, without a synchronous wait required on the side of the control program for the built-in software execution device.

The present invention is directed to a simulation system comprising a built-in software execution device to control a mechanism device by executing the control program, and a virtual mechanism simulation device which constructs a virtual mechanism model of the mechanism device and which allows the virtual mechanism model to run by simulation calculations, depending on the input data from the built-in software execution device. In such a simulation system, the present invention features in equipping a virtual mechanism model simulation device with a first processing unit to execute a first processing as a first task on the input and output to and from a built-in software execution device, and on the mechanism operation of the virtual mechanism model, and with a second processing unit which, by using free time of the first processing unit, executes a second processing as a second task on the user interface including drawing of the virtual mechanism model. In the present invention, paying attention on the point that the processing of a simulation device to allow a virtual mechanism model to run includes the processing of a motor command value input, mechanism operation and a sensor value output, as a high-speed, low-load processing, whose amount of processing is small and which can be computed at high speed, and as a low-speed, high-load processing, the processing concerning the user interface, such as the position/posture of component parts and drawing for display, whose amount of processing is large and which takes a lot of time, the present invention separates the processing of the simulation device into a high-speed, low-loading processing and a low-speed, high-loading processing, so that the high-speed, low-loading processing will be executed at high speed in the same periodicity as the control cycle from the control program, and the low-speed, high-loading processing will, as a result of thinning out, be executed at a time per several control cycles. By this separation, since no synchronous processing is required between the built-in software execution device and the simulation device for matching time, real time simulation of the virtual mechanism model can be embodied. The present invention equips the simulation device with two processors, and installs a first processing unit and a second processing unit separately, so that the input/output and the mechanism operation by the first processing unit, and the drawing processing by the second processing unit are executed in parallel. In addition, the present invention installs the first processing unit and the second processing unit to the processor for the simulation device in multitasking, and allows the input/output and the mechanism operation by the first processing unit to be executed in a short cycle, giving a high priority, and the drawing processing by the second processing unit to be executed in a long cycle, giving a low priority. In the case of multitasking, the processing of the first processing unit is allowed to be executed in a specified cycle, by synchronizing with the timer counter, and by doing so, simulation calculation can be executed in an accurate periodicity. Also on the simulation system under the present invention, when the mechanism device has a motor with periodic signals including pulsed signals or sinusoidal wave signals as input, for instance, a stepping motor, AC motor, PWM motor, etc., the simulation device can allow the virtual mechanism model to run by input of pulsed signals or sinusoidal wave signal to the motor, sent from the built-in software execution device as the motor command. The drawing processing to execute the second processing executes the drawing processing for the moving component parts of the virtual mechanism model. By this execution, the amount of processing concerning position calculation of component parts required for drawing and drawing for display can be reduced, thereby enabling the motion of the model to be displayed in nearly real-time state.

The simulation device of the present invention further includes a third processing unit which converts, for display, at least one of equivalent inertia, equivalent static friction and equivalent dynamic friction of the total load applied to an axis that is optionally selected from the relation of a predefined driving mechanism, into a value viewed from the selected axis. The third processing unit calculates and displays, in real time, a motor drive torque required for action, using equivalent inertia, equivalent static friction and equivalent dynamic friction of the total load, viewed from a motor drive shaft, applied to an axis which is optionally selected based on the relation of a predefined drive mechanism.

The simulation device of the present invention implements a torque motor for input data from the built-in software execution device, to thereby allow the virtual mechanism model to run. More specifically, at every predetermined simulation cycle, the simulation device repeats processings which include finding a target torque of a torque motor from command input data of the built-in software execution device; finding equivalent inertia, equivalent static friction and equivalent dynamic friction of the total load, viewed from a drive shaft of the torque motor; and finding the amount of displacement of the motor, from the obtained target torque, equivalent inertia, equivalent static friction and equivalent dynamic friction, so as to update the displacement of the motor. The simulation device stores input data from the built-in software execution device during simulation, together with time data, the simulation device replaying simulation again, using the stored data, after simulation.

The present invention provides a simulation method which constructs a virtual mechanism model of a mechanism device and which allows the virtual mechanism model to run by means of simulation calculations which depend on input data from a built-in software execution device, the method comprising a first processing step which includes executing a first processing on input/output to/from the built-in software execution device and on mechanism operations of the virtual mechanism model; and a second processing step which includes executing a second processing on a user interface including drawing of the virtual mechanism model, by use of a free time of the first processing step.

The present invention provides a program allowing a computer to execute a first processing step which includes executing a first processing on input/output to/from the built-in software execution device and on mechanism operations of the virtual mechanism model; and a second processing step which includes executing a second processing on a user interface including drawing of the virtual mechanism model, by use of a free time of the first processing step.

The present invention provides a computer readable record medium having a program stored therein, the program allowing the computer to execute a first processing step which includes executing a first processing on input/output to/from a built-in software execution device, and on mechanism operations of a virtual mechanism model; and a second processing step which includes executing a second processing on a user interface including drawing of the virtual mechanism model, by use of a free time of the first processing step.

The above and other aspects, objects, features and advantages of the present invention will become more apparent from the following detailed description when read in conjunction with the accompanying drawings.

### BRIEF DESCRIPTION OF THE DRAWINGS

FIG. 1 describes the conventional system, in which the actual machinery is connected to the built-in software execution device;

FIG. 2 describes the conventional system, in which the virtual mechanism model simulation device is connected to the built-in software execution device;

FIG. 3 is a flowchart of the conventional simulation including synchronous wait processing;

FIGS. 4A and 4B describe the system configuration under the present invention;

FIGS. 5A through 5C describe the simulated move when the moving component part of the virtual mechanism model is displayed;

FIGS. 6A and 6B depict the virtual mechanism model displayed on the monitor screen;

FIG. 7 is a flowchart of simulation processing shown in FIG. 4;

FIG. 8 describes an embodiment where two tasks are processed by two CPUs in parallel;

FIG. 9 describes an embodiment which executes processing by multitasking;

FIGS. 10A to 10C are flowcharts of simulation processing shown in FIG. 9:

FIG. 11 describes an embodiment which executes simulation, synchronizing with the timer interrupt;

FIG. 12 is a time chart for simulation processing shown in FIG. 11;

FIG. 13 is a flowchart of simulation processing as shown in FIG. 11;

FIG. 14 describes an embodiment which executes simulation by pulse command of the stepping motor;

FIG. 15 is a flowchart of an embodiment which executes simulation processing, including drive torque operation processing;

FIGS. 16A and 16B describe the concept of equivalent inertia;

FIG. 17 describes the calculation method of equivalent inertia moment;

FIG. 18 is a flowchart of algorithm to find inertia;

FIG. 19 is a flowchart of search algorithm for driving joints/component parts wanting to get equivalent inertia;

FIG. 20 is a detailed flowchart of driven joint search shown in FIG. 19;

FIG. 21 is a detailed flowchart of driven joint search shown in FIG. 19;

FIG. 22 is a detailed flowchart of equivalent inertia computation processing shown in FIG. 18;

FIG. 23 shows the concept of equivalent static friction;

FIGS. 24A and 24B are explanatory diagrams showing the concept of equivalent static friction when there are a plurality of driven relations;

FIGS. 25A and 25B describe the groove mechanism for rotation and translation;

FIG. 26 is a flowchart of equivalent static friction calculation processing;

FIGS. 27A and 27B show detailed flowcharts of equivalent static friction calculation processing shown in FIG. 26;

FIG. 28 is a flowchart of equivalent dynamic friction calculation processing;

FIG. 29 is a detailed flowchart of equivalent dynamic friction calculation processing shown in FIG. 28;

FIGS. 30A and 30B are flowcharts of motor driving torque calculation algorithm;

FIG. 31 describes the motor speed calculation shown in FIG. 30;

FIG. 32 describes a computer system which uses a record medium storing the simulation program subject to the present invention; and

FIG. 33 is a block diagram of the internal unit configuration of the main body shown in FIG. 31.

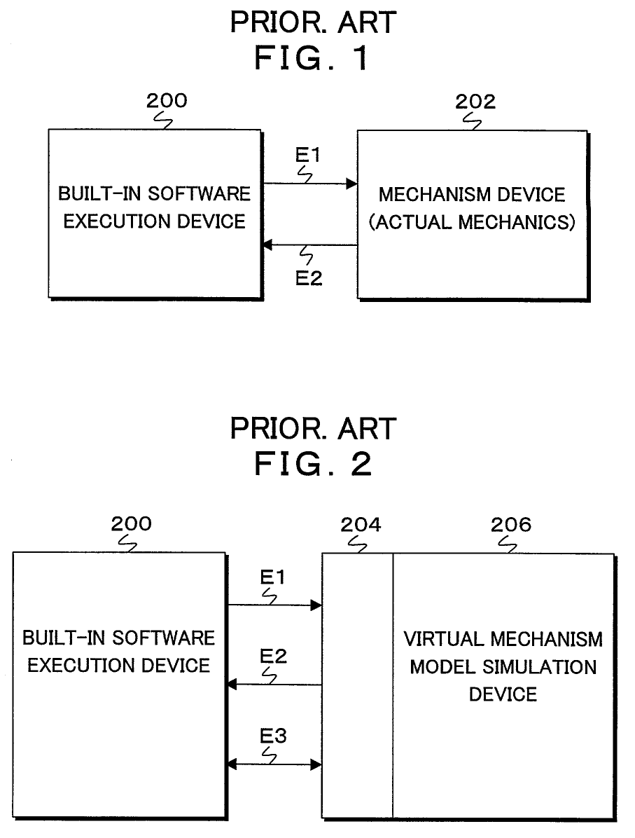

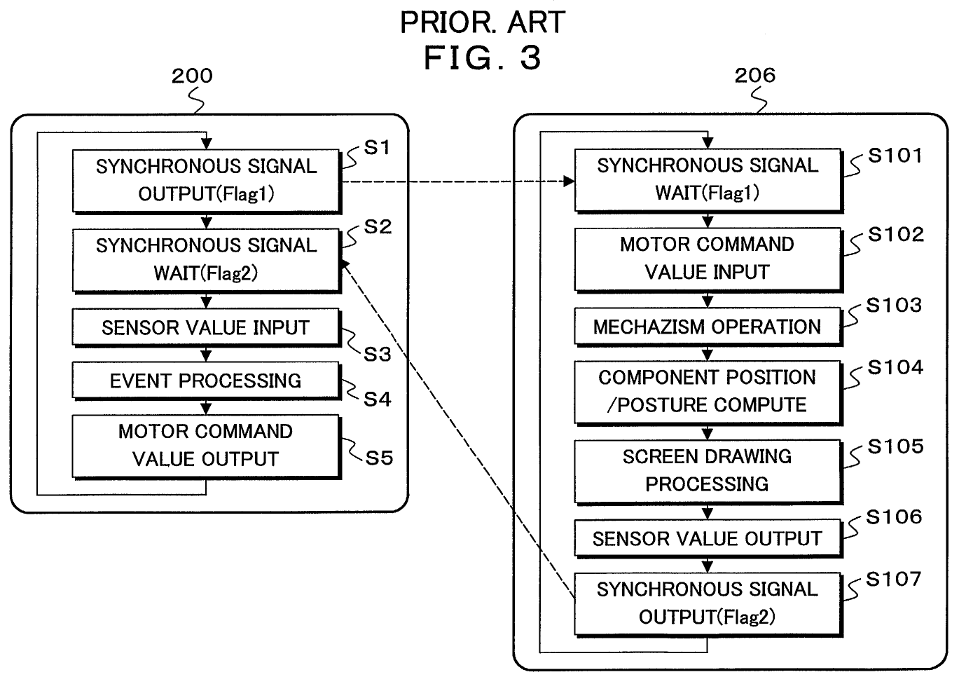

### DETAILED DESCRIPTION OF THE PREFERRED EMBODIMENTS

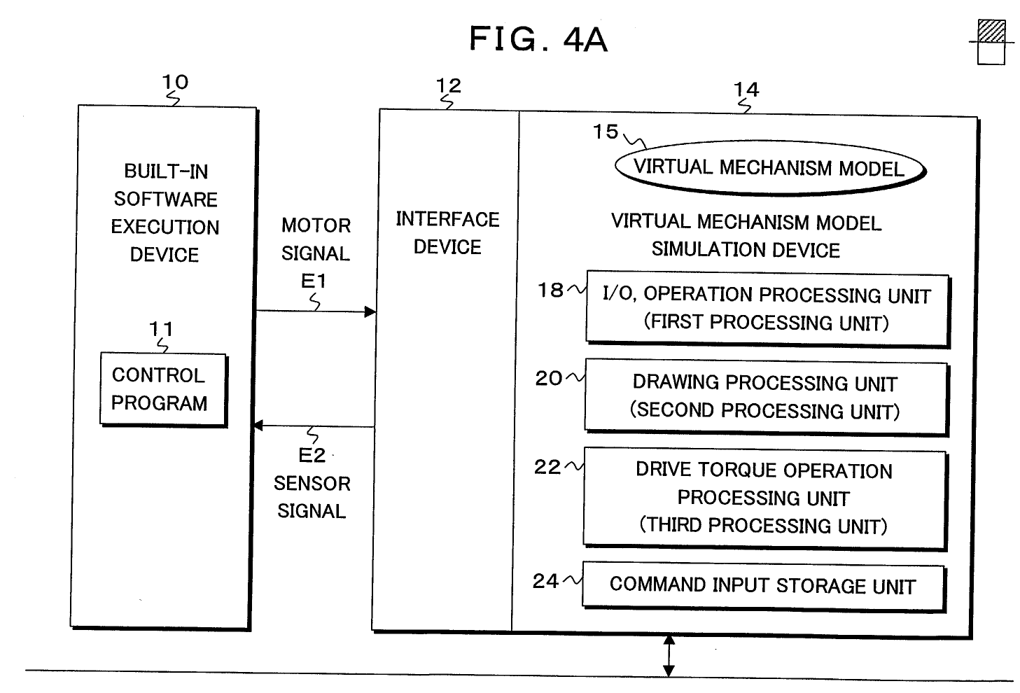

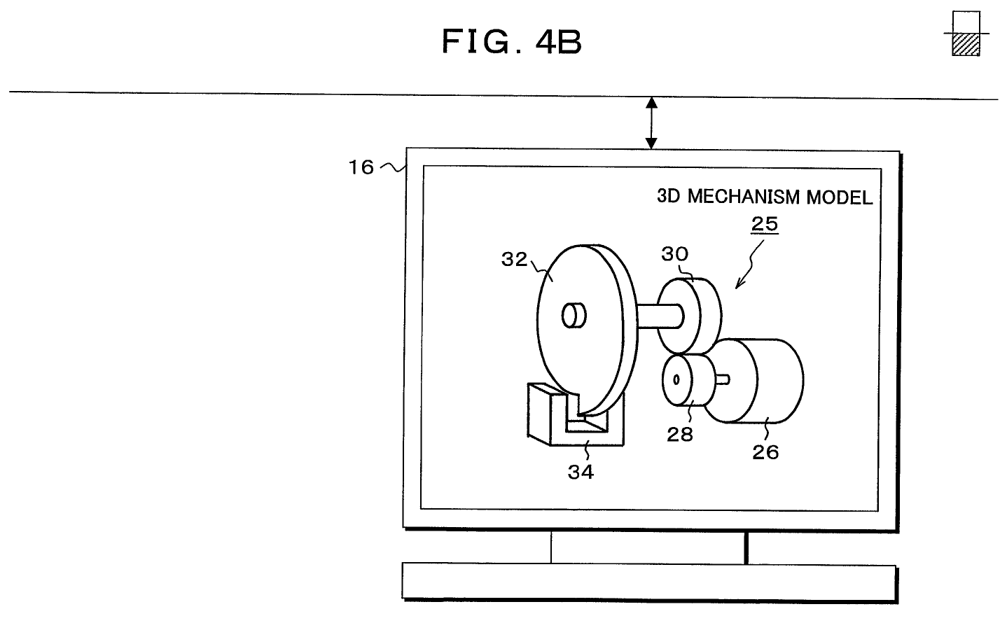

FIGS. 4A and 4B describe the system configuration of the simulation system under the present invention. The simulation system under the present invention comprises a built-in software execution device 10, a virtual mechanism model simulation device 14 equipped with an interface unit 12, and a display unit 16. A computer unit comprising a MPU memory hard disk, etc embodies each of the built-in software execution device 10 and the virtual mechanism model simulation device 14. To the built-in software execution device 10, a control program 11, which functions as a controller for mechanism device of control loading, is installed, and this control program is a prototype which is currently under development and designing or a finished product already developed and designed. The control program 11 repeats processing from output of a motor signal E1 as a motor command value in the periodicity of the loop sampling held by the built-in software execution device 10, to the virtual mechanism model simulation unit 14 through the interface unit 12, through read out of the result of the simulation from a sensor signal E2 showing the sensor value. For the virtual mechanism model simulation device 14, a virtual mechanism model 15, which was virtually constructed to accommodate a mechanism device subject to the control of the control program of the built-in software execution device 10, is prepared. The virtual mechanism model 15 can be created by CAD or the like, and makes up a three-dimensional mechanism model. In this embodiment, only component parts which move when simulation movement is executed are taken out of the virtual mechanism model 15 constructed on the virtual mechanism model simulation device 14, and displayed on the display device 16 as a three-dimensional mechanism model 25. The three-dimensional mechanism model 25 substantially representing these movable component parts will run based on the simulation calculation at the virtual mechanism model simulation device 14 corresponding to the motor signal E1 sent from the built-in software execution device 10. In other words, the three-dimensional mechanism model 25, for instance, connects a gear 28 of the output axis of a motor 26 to a gear 30, and by allowing a cam provided on the shaft of the gear 30 to turn, detects one turn of the cam 32 by a sensor 34. When the motor signal E1 is outputted from the built-in software execution device 10 as a motor command value to the motor 26, at the virtual mechanism model simulation device 14, the mechanism move for specified turns of the motor 26 of the three-dimensional mechanism model corresponding to the motor signal E1 is computed, and the positions of the gears 28 and 30 and the cam 30 are calculated based on the computation result of the mechanism operation, and the three-dimensional mechanism model in moved state by simulation will be displayed on the screen of the display device 16 as a second display by a three-dimensional second processing.

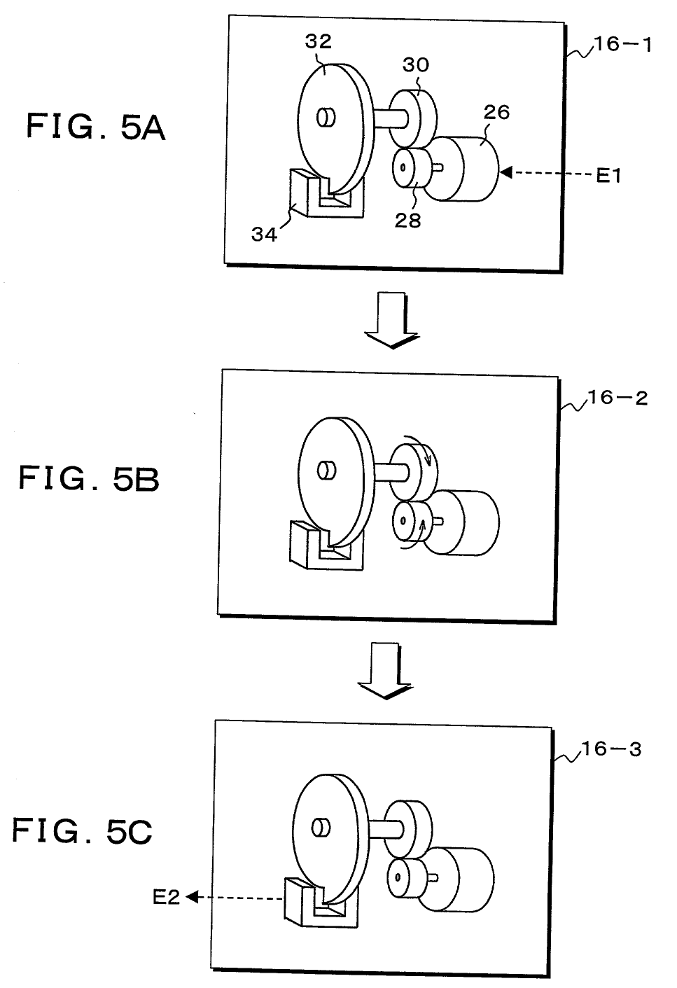

FIGS. 5A through 5C briefly show the analyzed motion of the three-dimensional mechanism model 25 by simulated motion displayed on the display device 16 shown in FIGS. 4A and 4B. On a monitor screen 16-1 shown in FIG. 5A, from the built-in software execution device 10, the motor signal E1 is sent to the motor 26, and rotation of the gear 30 is calculated depending on the rotation of the gear 28 of the motor output axis corresponding to the motor signal E1, thereby causing the cam 32 to perform rotational movement as shown in FIG. 5B. Thus, when the change in the gear position against the motor rotation is calculated, as shown in FIG. 5C, the sensor signal E2 from the sensor 34 generated by the move is eventually outputted to the built-in software execution device 10, thereby allowing the simulation device to perform simulation move in one loop sampling.

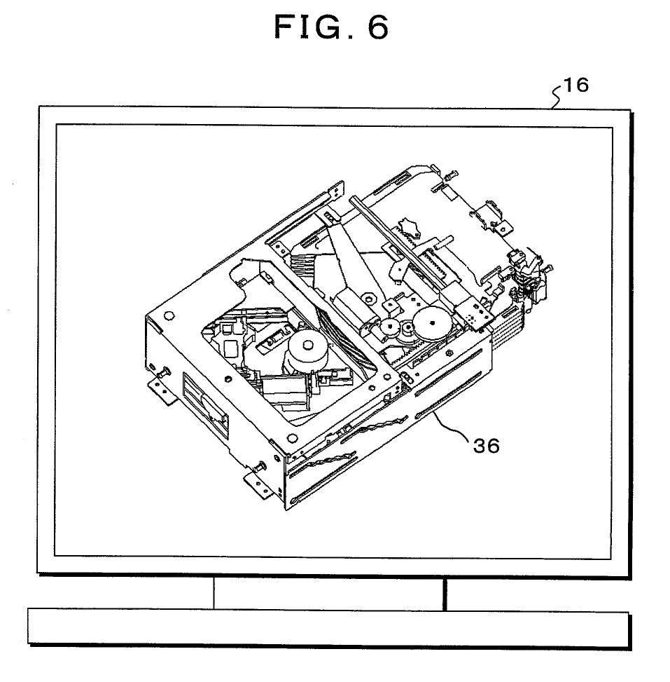

In the embodiments shown in FIGS. 4A and 4B, only component parts to be moved by the motor signal E1 are taken out of the virtual mechanism model 15 constructed on the virtual mechanism model simulation device 14 and displayed on the display unit 16 as the three-dimensional mechanism model 25. Not only these component parts to be moved, but also, for instance, like the display device 16 shown in FIGS. 6A and 6B, the overall three-dimensional model of the virtual mechanism model 15 subject to simulation, for instance, a CD changer as illustrated, may be displayed. In a preferable embodiment of the present invention, to embody a smooth move of the three-dimensional mechanism model by simulation on the display device 16, instead of the overall detailed image of the virtual mechanism model as shown in FIGS. 6A and 6B, for instance, like the display device 16 shown in FIGS. 4A and 4B, by allowing the display device to display only movable component parts of the three-dimensional mechanism model 25, including the motor and its loading mechanism, the amount of processing of the second process of the three-dimensional mechanism model 25 will be reduced, so as to shorten the processing time per one model drawing. Needless to say, processing to reduce the amount of data of a three-dimensional mechanism model to be drawn, and to shorten the processing time, includes the following methods:

(1) To change the shape of a model into a shape that can be drawn at high speed;

(2) To display the model in a two-dimensional cross-section;

(3) To enlarge (zoom in) the entire model to reduce the space for displaying component parts of the model; and

(4) To display only the moving component parts, and in the above-described methods, the most convenient method is the method to display only moving component parts as described in (4), and in addition, this method can maintain a merit of not damaging the feature in the capability of checking the three-dimensional motion under simulation from any optional viewpoint, even if the amount of data of the model is reduced to the data only concerning the moving component parts. As described above, in order to allow the three-dimensional mechanism model to be expressed only by the moving component parts on the screen, the only required work is to extract the moving component parts from the virtual mechanism model 15 constructed on the virtual mechanism model simulation device 14, before starting simulation. In other words, as the virtual mechanism model 15 constructed on the virtual mechanism model simulation device 14 sets up the joints that move to simulate the movement of the model, and the joint-to-joint interlocked relation, for instance, gear ratio, and further, the component part-to-part connected relation as data, by the extraction of indirect component parts and component parts connected to the indirect component parts, the extraction of moving component parts can be made, for instance, like the three-dimensional mechanism model shown in FIGS. 4A and 4B. As described above, on the simulation device shown in FIGS. 4A and 4B for the virtual mechanism model, to the virtual mechanism model simulation device 24, each function, including an I/O operation processing unit (a first processing unit) 18, a drawing processing unit (a second processing unit) 20, a drive torque operation processing unit (a third processing unit) 22, and a command input storage device 24, is set up. Out of these functions, a processing unit to perform simulated movement of the three-dimensional mechanism model 25 upon receiving the input of the motor signal E1 from the built-in software execution device 10 basically comprises the first processing unit 18 and the second processing unit 20. The first processing unit 18 that functions as an I/O operation processing unit executes the operation to calculate the input and output of the motor signal E1 and sensor signal E2 between the processing unit and the built-in software execution device 10, via an interface device 12, and further executes the mechanism operation to calculate the movement of all mechanism elements for the movement of the motor, in accordance with the model definition when the motor signal E1 is inputted to the virtual mechanism model 15 constructed on the device. Against this, the second processing unit 20 executes a second process to display the three-dimensional mechanism model 25 on the display device 16 based on the result of the operation made by the first processing unit 18. On the virtual mechanism model simulation device 14 under the present invention, by separating the simulation processing of the virtual mechanism model 15 into processing of the first processing unit 18 and processing of the second processing unit 20, synchronous processing wait is not required on the side of the built-in software execution device 10, and simulated movement depending on the command value sent from the control program 11 can be actually executed in real time.

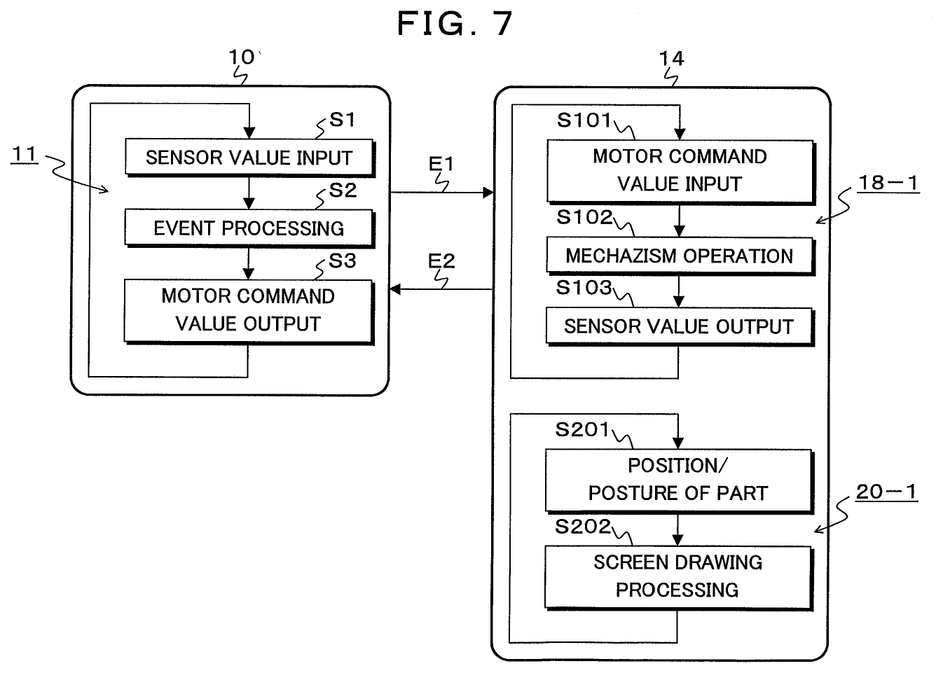

FIG. 7 shows a flowchart of the control program 11 for the built-in software execution device 10 shown in FIGS. 4A and 4B and a flowchart of a first task 18-1 by the first processing unit 18 and a second task 20-1 by the second processing unit 20 set up at the virtual mechanism model simulation device 14. The control program 11 for the built-in software execution device 10 repeatedly manipulates the sensor value input at the step S1 in the periodicity of the specific loop sampling of the device, event processing at the step S2, and further the motor command value output at the step S3. When the motor command value output at the step S3 is executed by the control program 11, the motor signal E1 corresponding to the output will be sent to the virtual mechanism model simulation device 14 through the interface device 12. The motor signal E1 is fetched by processing the motor command value input at a step 101 of the first task 18-1, and at a next step S102, this signal executes the mechanism operation of the virtual mechanism model. This mechanism operation sets in advance how the virtual mechanism model moves depending on the motor command value, before simulation, and is to move the virtual mechanism model during simulation according to the setting. More specifically, like the three-dimensional mechanism model 25 displayed on the display device 16 in FIGS. 4A and 4B, to the motor 26, the mechanism elements, including gears 28 and 30, and the cam 32 are connected, and these interlocked relations are already set in advance for the three-dimensional mechanism model. As to the interlocked relation of the model, in the case of gears, by setting gear ratio, and in the case of cams, by collecting the positional relation of driving and driven into a table, reduction is planned in the calculation process of move caused by interlock. During simulated move, by using the interlocked relation of the mechanism elements of the three-dimensional mechanism model 25, the motions of all the mechanism elements, for instance, the gears 28 and 30 and the cam 32 depending on the move of the motor 26 are calculated. By this mechanism operation, new positions or postures of the gears 28 and 30 or the cam 32, and further at the sensor 24 provided for the cam 32 will be determined. Therefore, as the sensor value will be finally determined at a step S103, the determined sensor value will be outputted to the control program 11 for the built-in software execution device 10 as the sensor signal E2. The motor command value input mechanism operation and sensor value output making up the first task 18-1 can be calculated at high speed because the amount of data processing is relatively small. Therefore, the first task 18-1 can execute calculation process in the same high-speed periodicity as the loop sampling of the built-in software execution device 10. Against the first task 18-1 which is able to execute high-speed calculation, in the present invention, a second task 20-1 for drawing the motion of the model caused by the result of the simulation calculation is isolated as an independent task. The second task 20-1 includes the position/ posture calculation of the component parts at the step S201 and drawing processing for display at the step 202. The position/ posture calculation of the component parts and drawing processing for display have a large amount of data processing in the total simulation calculation and the calculations are time-consuming process. On the conventional simulation device, as the second task 20-1 has not been separated from the first task 18-1 which is able to execute calculation at high speed, and these tasks have been processed together as if a single process, processing of synchronous wait has been required on the side of the built-in software execution device 10 for synchronous processing to eliminate the time lag of the second task 20-1. However, under the present invention, by simulation calculation is separated into two tasks, the first task 18-1 which is a high-speed, low-loading process, and the second task 20-1, which is a low-speed, high-loading process, as to the first task 18-1, calculation is executed at high speed, in the same periodicity as the loop sampling of the built-in software execution device 10, and while as to the second task 20-1, by the second task is allowed to execute thinned out processing only once for every plural times of executions made by the first task 18-1, real time simulation can be embodied that does not require synchronous processing with the built-in software execution device 10.

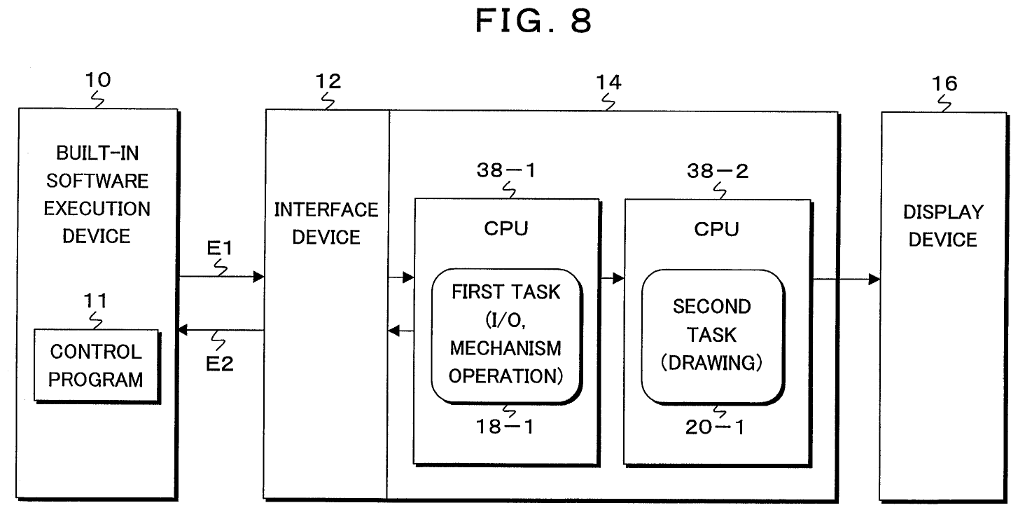

FIG. 8 shows an embodiment of configuration of the virtual mechanism model simulation device 14 for executing two tasks, which were already separated into the first processing unit 18 and the second processing unit 20 at the virtual mechanism model simulation device 14 shown in FIGS. 4A and 4B. The feature of this embodiment is that two CPUs 38-1 and 38-2 are provided on the virtual mechanism model simulation device 14, and the two tasks, the first task 18-1 and the second task 18-2, separated by the CPUs 38-1 and 38-2, respectively, to be executed in parallel. In other words, the CPU 18 inputs the motor signal E1 from the built-in software execution device 10 through the interface device 12, and executes at high speed the motor command value input mechanism operation and sensor value output at the step S101 through step S103 as shown in the first task 18-1 in FIG. 7. The result of executing the first task 18-1 is sent to the second task 20-1 of the CPU 38, and against several times of executions of the first task 18-1, the position/posture calculation of the component parts at the step S201 as given in the second task 20-1 shown in FIG. 7, and the drawing processing for display at the step S102 based on the calculation result are executed by the second task 20-1 only one time, as a result of thinning.

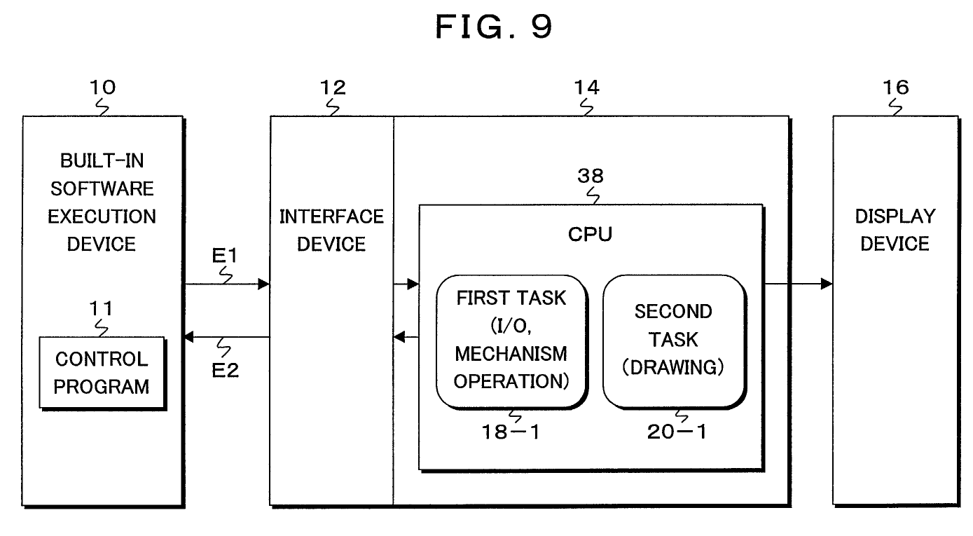

FIG. 9 shows another embodiment of the virtual mechanism model simulation device 14 to execute simulation process which is already divided into two tasks under the present invention. In this embodiment, only the single CPU 38 is provided for the virtual mechanism model simulation device 14, and on the only single CPU 38, simulation process divided into two tasks, the first task 18-1 and the second task 20-1 are executed. As described above, processing to execute two tasks on the CPU 38 can be installed on the OS having multitask function, generally, on the OS having multitask function, a specific priority of execution can be set for every task. Therefore, in simulation processing under the present invention, as to the first task 18-1, a higher priority is set compared with other tasks including the second task 20-1, and against the motor signal E1 from the built-in software execution device 10, the first task is allowed to be able to execute simulation calculation and to make response in real time without being affected by other processing. Against this, as to the second task 20-1, a lower priority than the first task 18-1 is set, to allow processing of the second task 20-1 to be executed while processing of the first task 18-1 is suspended. For this purpose, sleep processing is added in the loop processing of the first task 18-1 to suspend process for a specified time, and compensation is made so that the second processing by the second task 20-1 can be executed, during the sleep processing.

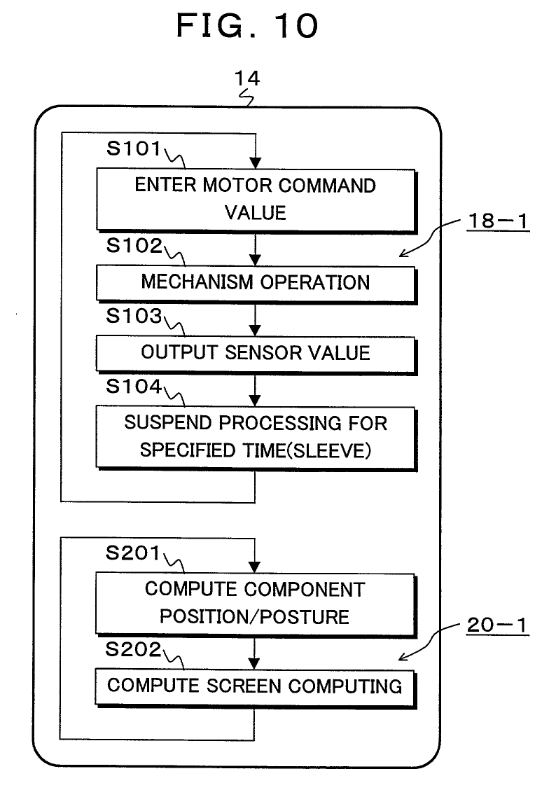

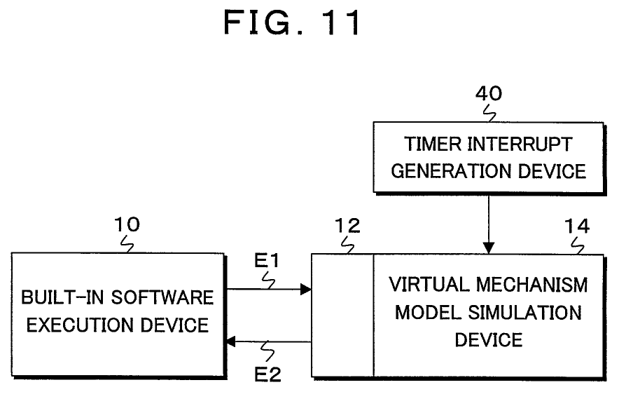

FIGS. 10A to 10C show flowcharts of the first task 18-1 and the second task 20-1 installed on the OS having a multitask function as shown in FIG. 9. In the first task 18-1, input of the motor command value at the step S101, mechanism operation at the step S102, the sensor value output at the step S103, as well as sleep processing at the step S104 to suspend processing for a specified time are provided. As described, by the first task 18-1 which operates in real time is allowed to contain the sleep processing, during sleep processing, execution of the second task 20-1 having lower priority than the first task can be guaranteed, and by this, the second task 20-1 can be executed in thinned-out frequency, compared with the execution frequency of the first task 18-1.

FIG. 11 shows another embodiment in the case of executing two tasks, the first task 18-1 and the second task 20-1 on the single CPU 38, same as shown in FIG. 9, installed on the OS having a multitask function. This embodiment features the use of timer interrupt for executing process in accurate time period of the first task 18-1. To the built-in software execution device 10, the virtual mechanism model simulation device 14 is connected through the interface device 12, so as to input the motor signal E1 and output the sensor signal E2. In addition, in this embodiment, a timer interrupt generation unit 40 is newly installed to the virtual mechanism model simulation device 14. As to simulation processing at the virtual mechanism model simulation device 14, in case of calculating motions of the virtual mechanism model, as the amount of move is determined from the motor speed and simulation time at a time, time management becomes important. Therefore, as shown in FIG. 11, for the virtual mechanism model simulation device 14, the timer interrupt generation device 40 is provided, to allow processing of the first task 18-1 that runs in real time to be executed in an accurate time cycle.

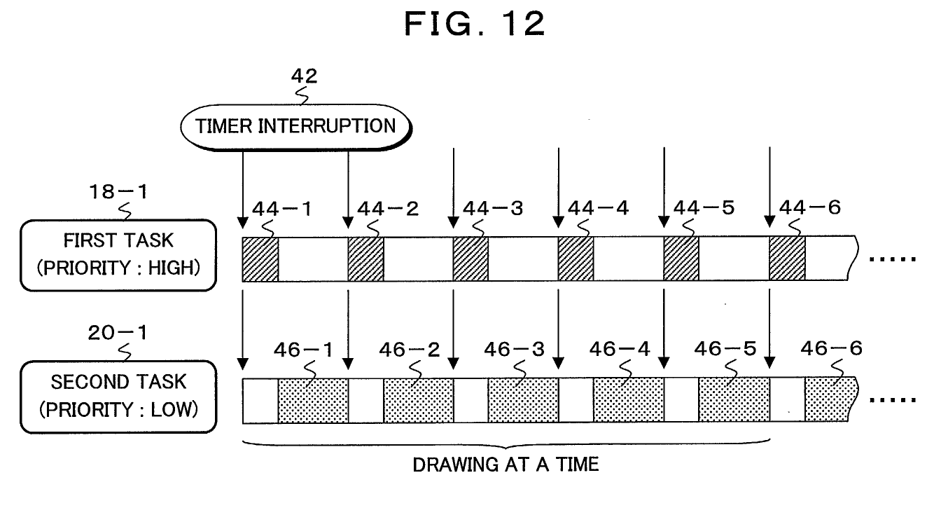

FIG. 12 shows a time chart of simulation process by timer interrupt, and against the first task 18-1, for which a higher priority was set, by a timer interrupt 42 from the timer interrupt generation device 40, interruption is caused once every specified hours, and by allocation of tasks 44-1, 44-2, and so on of the first task 18-1 for every timer interrupt 42, execution in an accurate time cycle can be embodied. As the timer interrupt generation device 40 to perform a timer interrupt 42, a timer function of the OS or a timer unit of other devices may be used. Needless to say, the timer interrupt 42 from the timer interrupt generation device 40 surely has a further higher priority than the priority set for the first task 18-1. As described, because the first task 18-1 is executed synchronizing with the timer interrupt 42, like task 44-1, 44-2, and so on, free time other than the tasks 44-1, 44-2 and so on, of the cycle of the timer interrupt 42 can be allocated to tasks 46-1, 46-2, and so on of the second task 20-1 having lower priority than the first task. And, in an example of the time chart, by the tasks 46-1 through 46-5 of the second task 20-1, to which the free times of the five tasks, 46-1 through 44-5 of the first task 18-1, synchronized with the timer interrupt 42 are allocated, thinned out processing of the second process can be made one time.

Also, as the method of starting the second task 20-1, subject to thinned-out processing, a method to perform the next process, immediately after the previous process finished, or a method to start the task at established periods, either one of the two can be used.

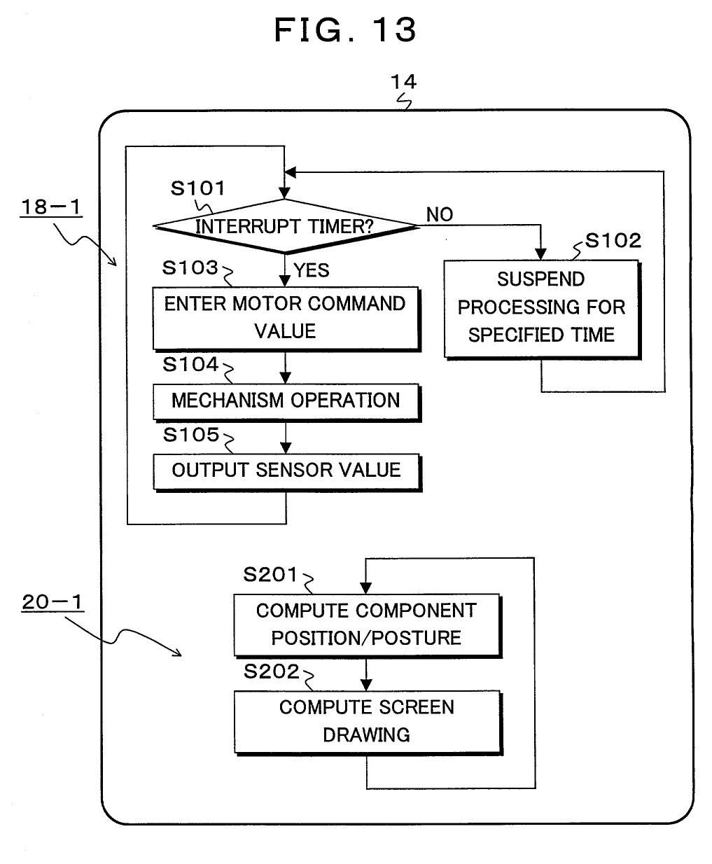

FIG. 13 shows flowcharts of the first task 18-1 and the second task 20-1 of the virtual mechanism model simulation device 14 in an example of executing simulation processing by timer interrupt shown in FIGS. 11 and 12. First, the first task 18-1, which is subject to high-speed calculation, is waiting for timer interrupt at the step S101, and if timer interrupt does not occur, processing at the step S102 will be suspended for a specified period of time, in short, sleep processing will be executed. While processing is suspended, at the second task 20-1, the position/posture calculation of the component parts of the step S201 and step S202 and the drawing calculation for display are dividedly executed. When timer interrupt is identified at the step S102, at the step S103, the motor command value is inputted, at the step S104, mechanism operation is executed, and further at the step S105, the sensor value is outputted, then, a series of sampling group will be finished, and again at the step S101, the program will wait for the next timer interrupt. Here, the virtual mechanism model simulation device 14 under the present invention executes tasks other than the first task 18-1 and the second task 20-1 required for simulation process, for instance, task to receive a mouse event and process the event, task to store the input data in the storage, etc. And, as to tasks other than simulation process, by setting of lower priority for the task, processing to respond to the high-speed built-in software execution device 10 can be secured, without suspending of simulation process. As described, because lower priority is set for such tasks to handle mouse event or to store data, the entire model can be allowed to turn, or zooming in can be made by the mouse operation, during simulation, and the first task 18-1 which is performing high-speed calculation by the mouse operation will not be suspended, thereby causing the built-in software execution device 10 to be free from synchronous process.

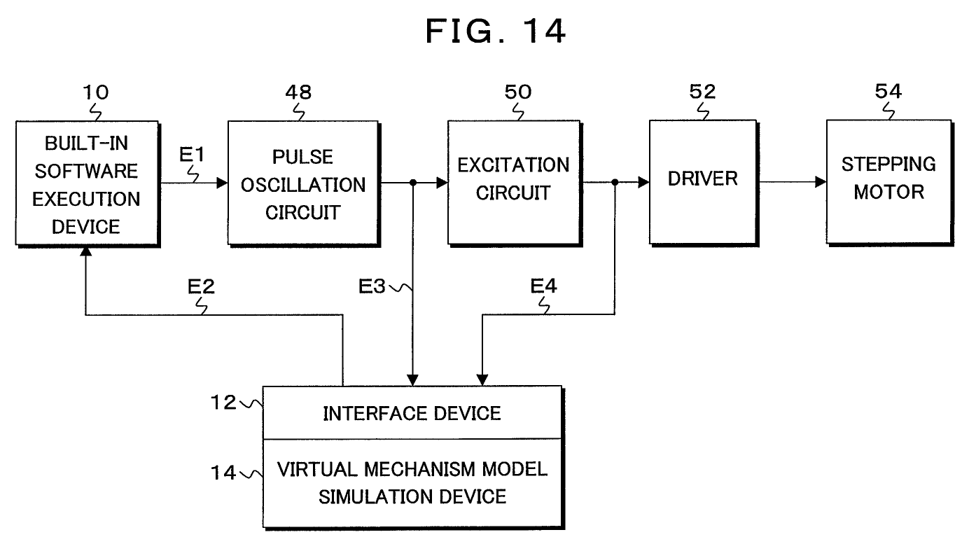

FIG. 14 shows another embodiment of the simulation system under the present invention, and this embodiment features in performing simulation, inputting the pulsed signal of a stepping motor as the command value. In other words, in the conventional simulation processing requiring synchronous process as shown in FIG. 11, as a built-in software execution device 100 performing synchronous processing, and a device to output pulsed signals are standalone, pulsed signals will be outputted freely even if synchronous process is in progress, thereby giving rise to a problem that simulation to input pulsed signals cannot be executed. Against this, under the present invention, synchronous process is not required between the built-in software execution device 10 and the virtual mechanism model simulation device 14, thus, pulsed signals can be inputted to the virtual mechanism model simulation device 14 in real time. This can embody simulation process at the virtual mechanism model simulation device 14 constructing a virtual mechanism model corresponding to a mechanism device equipped with a stepping motor driven by a pulse motor.

In FIG. 12, to the built-in software execution device 10, in order to drive a stepping motor 54 mounted on a mechanism device as a real machinery, a pulse oscillation circuit 48, an excitation circuit 50 and a driver 52 will be installed. The built-in software execution device 10 allows the pulse oscillation circuit 48 to start, by outputting the motor signal E1, and by this activation, from the pulse oscillation circuit 48, pulsed signals E3 will be continuously outputted in a given cycle till the circuit stops, to drive the stepping motor through the excitation circuit 50 and the driver 52. Against such a driving system for the stepping motor 54, to the virtual mechanism model simulation device 14 under the present invention, through the interface device 12, for instance, pulsed signals E3 from the pulse oscillation circuit 48 will be inputted. This input of pulsed signals to the virtual mechanism model simulation device 14 may use pulsed signals E4 from the output of the excitation circuit 50. The virtual mechanism model simulation device 14 will allow the model to run, performing simulation calculation corresponding to one pulse, because against the input of the pulsed signal E3, the rotation amount of the stepping motor 54 per one pulse is defined in advance.

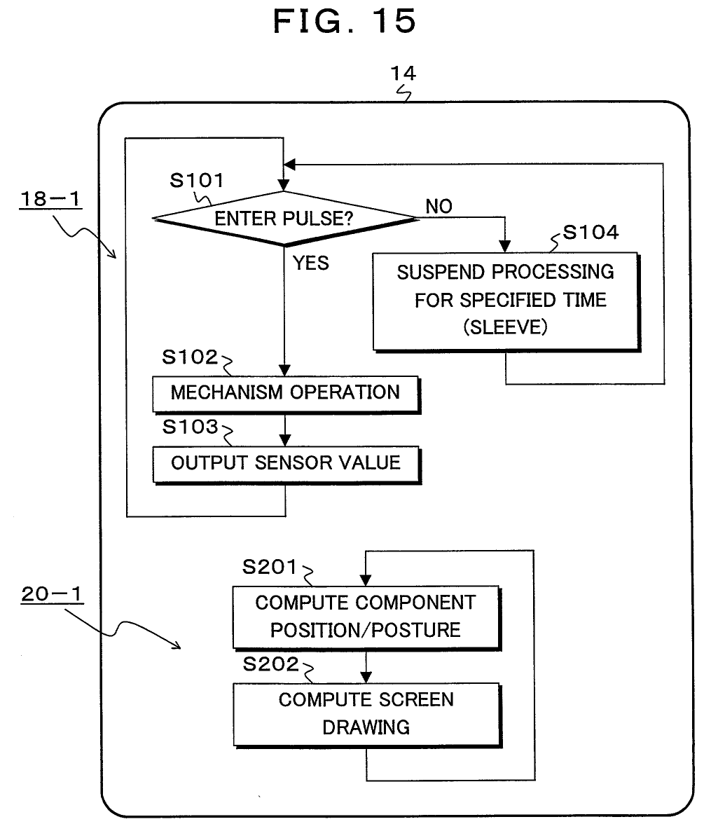

FIG. 15 shows flowcharts of the first task 18-1 and the second task 20-1 at the virtual mechanism model simulation device 14 applying to the stepping motor shown in FIG. 14. The first task 18-1 inputs one pulse as the motor command value at the step S101, at the step S102 executes the mechanism operation corresponding to the rotational amount of the stepping motor that is pre-determined per one pulse, and at step S103 outputs the sensor value. Then, at the step S106, after performing sleep processing to suspend processing for a given period of time, the task again returns to the step S1 to input one pulse. While the second task 20-1 executes the position/posture calculation of the component parts at the step S104, and the drawing calculation for display at the step S202 in time-sharing, while processing of the first task 18-1 at the step S104 is suspended for a given period of time, thereby resulting in thinned-out second process to be performed.

Again referring back to FIGS. 4A and 4B, to the virtual mechanism model simulation device 14, a command input storage unit 24 is installed. In the case of simulating the three-dimensional mechanism model 25 in real time, based on the motor signal E1 sent from the built-in software execution device 10 under the present invention, as the three-dimensional mechanism model runs at the same speed as the speed of the actual mechanism device, it would be difficult to verify and analyze the motion while looking at the model displayed on the display device 16. To such a problem, the method to animate the display screen during simulation, and to replay after simulation can be planned, however, it is difficult to simultaneously manipulate simulation and animated videotape on the same computing machine. Therefore, under the present invention, by the command input storage unit 24 installed to the virtual mechanism model simulation device 14, all the motor signals E1 inputted from the built-in software execution device 10 are to be stored with the time data, and by adjusting of the time when a motor signal from the stored data is generated using the stored data, the same motion can be perfectly replayed at any optional speed. As the data to be actually stored by the command input storage unit 24, time during simulation and the value of the motor signal E1 would be proper. Also, during simulation, the second process is handled as thinning-out process; however, the move may be expressed in detail, like in slow motion, without thinning-out process to be performed, as there is sufficient time to spare in replaying.

Next, a processing function of a drive torque operation-processing unit 22 installed to the virtual mechanism model simulation device 14 shown in FIGS. 4A and 4B is described. Calculation of drive torque at the drive torque operation-processing unit (a third processing unit) 22 installed to the virtual mechanism model simulation device 14 shown in FIGS. 4A and 4B is made on the three-dimensional mechanism model 25 displayed on the display unit 16, for instance, to calculate equivalent inertia (output amount and moment) of the total load applied to the drive shaft of the motor 26, equivalent static friction and equivalent dynamic friction, and using these equivalent inertia, equivalent static friction and equivalent dynamic friction, to calculate the drive torque required for loading motion in real time, to display on the screen of the display unit 16. The drive torque operation processing unit 22 can also similarly calculate equivalent inertia which is being operated as a parameter for calculating drive torque, equivalent static friction and/or equivalent dynamic friction in real time and display on the screen, in addition to the calculation and display of drive torque itself. Therefore, after detailed description about the individual equivalent inertia required for calculating and displaying the drive torque, equivalent static friction and equivalent dynamic friction, calculation process of drive torque will be described.

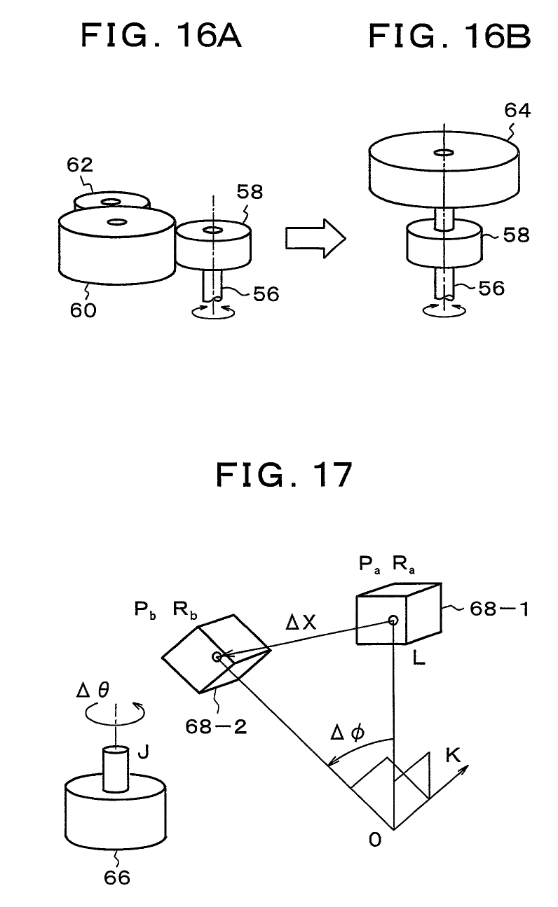

FIGS. 16A and 16B explain the concept of equivalent inertia. Equivalent inertia means inertia (moment) of a series of driven joints (loading), like the driving axis 56, gears 58, 60 and 61 shown in FIG. 16A is converted into a value when viewed from the driving axis 56 of the motor, which will be a driving joint as shown in FIG. 16B and displayed. Wherein, the gear 64 represents the gears 60 and 62 shown in FIG. 6A. As described, by using of equivalent inertia (moment) viewed from the motor, which is to say a driving joint, it can be easily known how much load the motor has, specific torque required for running at optional angular acceleration, or acceleration of loading obtained by optional torque, and the obtained knowledge would be useful in selecting motors. Here, first the method to find equivalent inertia (moment) will be described; next, the method to calculate equivalent inertia (moment) on mechanism analysis software will be explained.

First, how to find equivalent inertia will be explained. When mass of the component part making up the joint is represented by m, and inertia moment by I, kinetic energy of the component part can be expressed by

$$E = \frac{1}{2} {m ( \frac{ⅆ x}{ⅆ t} )}^{2} + \frac{1}{2} {I ( \frac{ⅆ φ}{ⅆ t} )}^{2} \qquad ( 1 )$$

Where, χ and ø are joint values for straight-ahead travel and rotation, respectively.

When the value of equivalent inertia moment viewed from the driving joint (motor) is represented by Ieq, and the joint value by ø, from the kinetic energy preservation rule,

the relation

$$\frac{1}{2} {{I}_{eq} ( \frac{ⅆ θ}{ⅆ t} )}^{2} = \frac{1}{2} m {( \frac{ⅆ x}{ⅆ t} )}^{2} + \frac{1}{2} {I ( \frac{ⅆ φ}{ⅆ t} )}^{2} \qquad ( 2 )$$

holds. This equation is solved to find the equivalent inertia moment Ieq, and

$$\begin{matrix}{I}_{eq} = {m ( \frac{\frac{ⅆ x}{ⅆ t}}{\frac{ⅆ θ}{ⅆ t}} )}^{2} + {I ( \frac{\frac{ⅆ φ}{ⅆ t}}{\frac{ⅆ θ}{ⅆ t}} )}^{2} \\ = {m ( \frac{ⅆ x}{ⅆ θ} )}^{2} + {I ( \frac{ⅆ φ}{ⅆ θ} )}^{2}\end{matrix} \qquad ( 3 )$$

is obtained. This is the equivalent inertia moment of the component part (load) viewed from the motor shaft. Also, in the case of the translation joint with which the motor performs straight-line reciprocating motion, equivalent inertia moment meq of the component part is similarly expressed by

$${m}_{eq} = {m ( \frac{ⅆ x}{ⅆ y} )}^{2} + {I ( \frac{ⅆ φ}{ⅆ y} )}^{2} \qquad ( 4 )$$

Wherein, y denotes the joint value of the motor joint.

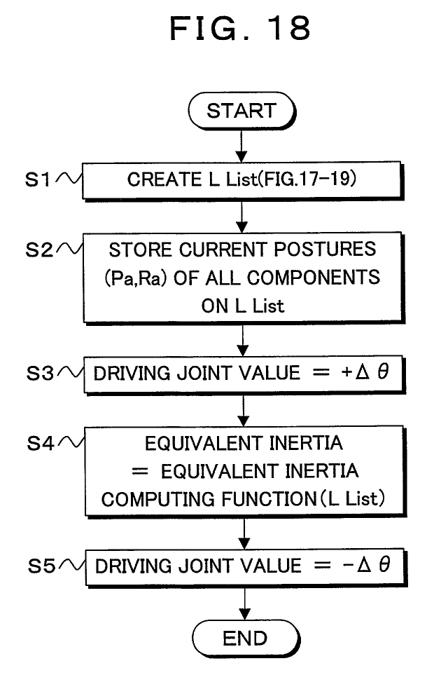

Next, description is made on the method to seek equivalent inertia by using mechanism analysis software. In the first place, as a pre-condition, mechanism analysis software is required to contain the preset mechanism relation of the gear, cam, roller, clutch, ratchet, etc., and based on this mechanism relation, when the driving joint changes, the driven joint will move, and depending on the move, the posture of the individual component parts of each driven joint will change, thus, this mechanism relation is used for three-dimensional drawing. Here, the posture of the component part is expressed by position (P) and rotational matrix (R). To obtain equivalent inertia, such a change in the posture of each component part is utilized. In other words, as shown in FIG. 17, when the driving joint (J) of a motor 66 is moved by

Δθ, by the joint relation, the driven component part L will change its posture from posture 68-1 to posture 68-2. When this amount of change is supposed to be expressed by the amount of straight-line travel Δx of the center of gravity of the component part L, and the amount of rotation Δø around a certain unit vector K axis, from the equation (3) or equation (4), equivalent inertia Ieq of the component part L can be obtained from

$${I}_{eq} = {m ( \frac{Δ x}{Δθ} )}^{2} + {I ( \frac{Δφ}{Δθ} )}^{2} \qquad ( 5 )$$

Wherein, n denotes the amount of protrusion of the component part L, and I denotes inertia moment of the component part L around the K axis. The posture of this component part L can be obtained by position P and rotation matrix R. Therefore, from the posture (Pa, Ra) of the component part L before change, and the posture (Pb, Rb) of the component part L when the driving joint J changed by Δθ, the amount of straight-line travel of the center of gravity Δx, amount of rotation around the unit K axis Δø, and inertia moment I must be found, by using

$$\begin{matrix}Δ x = \vert {P}_{b} - {P}_{a} \vert & ( 6 ) \\ Δφ = {cos}^{- 1} \frac{{r}_{11} + {r}_{22} + {r}_{33}}{2} & ( 7 ) \\ I = IK & ( 8 )\end{matrix}$$

Provided, that r11, r22 and r33 are elements of matrix that can be expressed by

$$( \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ) = {R}_{b} {R}_{a}^{- 1} \qquad ( 9 )$$

and, L is inertia tensor of the component part L. Further, unit matrix can be expressed by equations such as

$$K = \frac{1}{2 sin Δθ} {( {r}_{32} - {r}_{23} , {r}_{13} - {r}_{31} , {r}_{21} - {r}_{12} )}^{T} \qquad ( 10 )$$

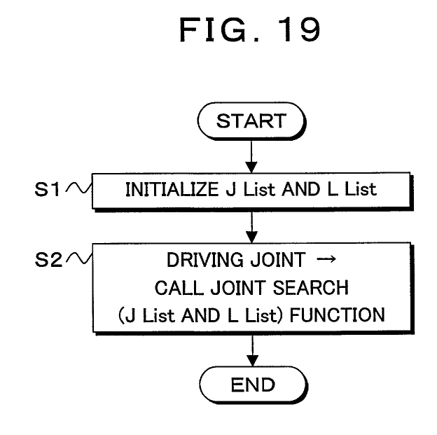

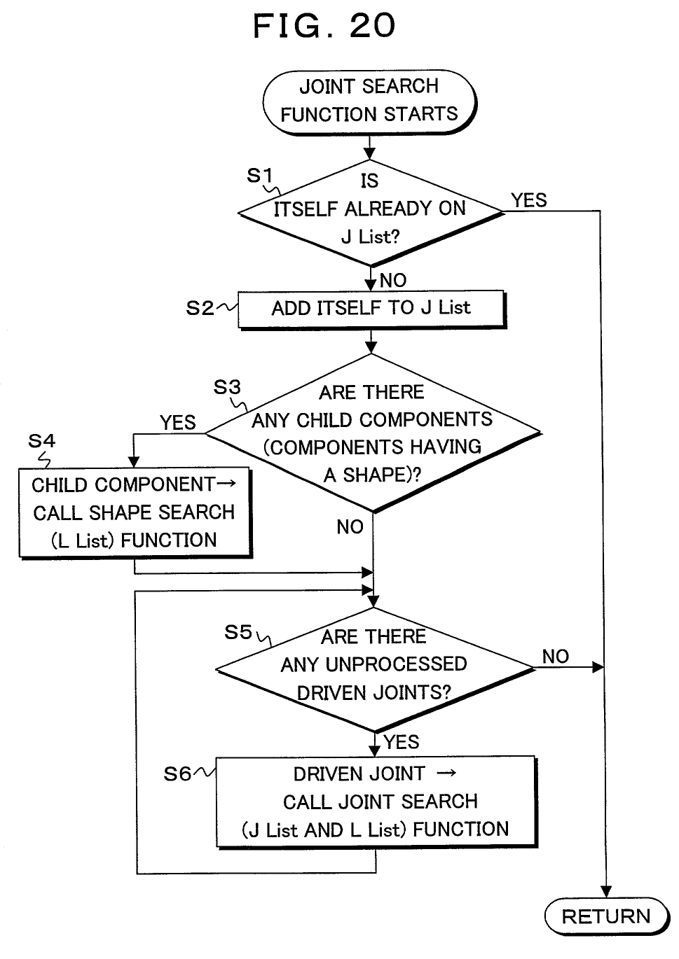

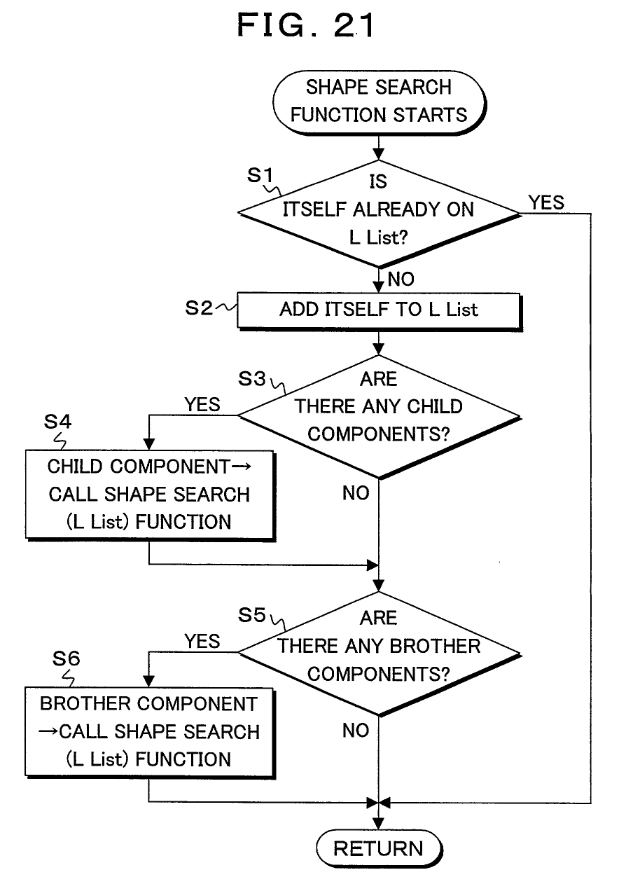

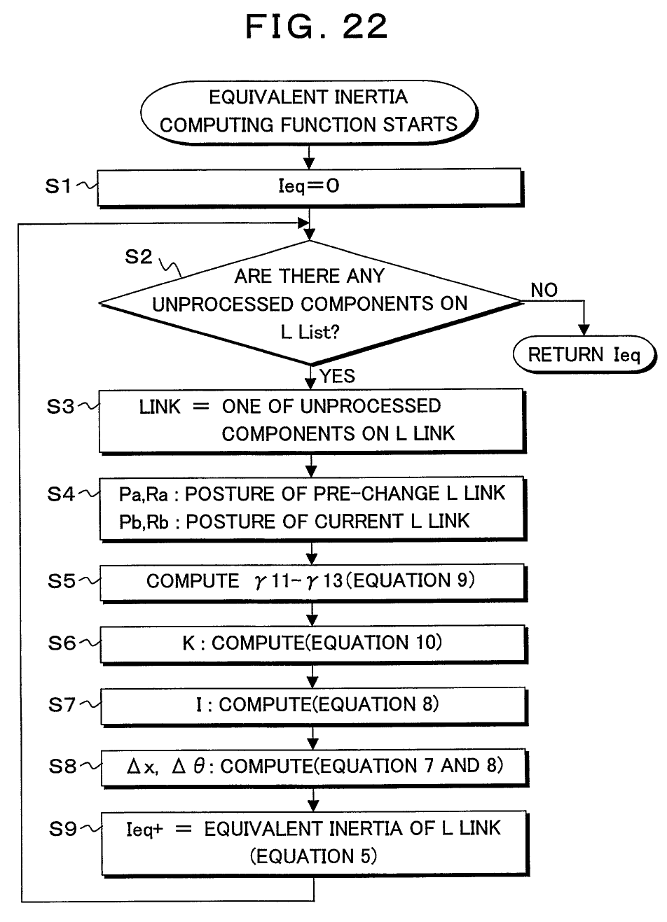

FIG. 18 is a flowchart of the main routine of algorithm to find equivalent inertia. First, at a step S1, a list (L List) of all the component parts making up the driven joints of the driving joint, whose equivalent inertia is required, is created. Processing for creating this L list of component parts is as shown by the flowcharts shown in FIGS. 19, 20 and 21. FIG. 19 shows the main routine to create components parts list, and at the step S1, after initialization of component parts list J List for the driving joint and the component parts list L list for the driven joint, at a Step S2, search function for each list is called out. FIG. 20 shows a flowchart of search algorithm of the component parts list for the driving joint. And FIG. 21 shows a flowchart of search algorithm of the component parts list for the driven joint. Again FIG. 18 is looked at, next, at the step S2, the current posture (Pa, Ra) of each component part is stored as to all the component parts on the component parts list L list. Continuing from the previous step, at the step S3, the value of the driving joint is increased by Δθ, to move the driving component parts. Corresponding to the increase in the value of the driving joint, equivalent inertia calculation function shown in FIG. 22 is called out to calculate equivalent inertia at a step S4. The flowchart of equivalent inertia calculation function shown in FIG. 22 is to find Δx of posture, Δø and I, from the current posture (Pb, Rb) and the posture (Pa, Ra) before change obtained at the step S2 shown in FIG. 18, for all the driven component parts, so as to obtain equivalent inertia of each component part. To be more specific, at the step S1, after initialization of equivalent inertia Ieq to 0, at the step S2, checking is made if there are any unprocessed component parts on the component parts list L list, and if there are any unprocessed component parts, at the step S3 through step S9, equivalent inertia is sequentially calculated every component part, so as to find a final equivalent inertia by addition of equivalent inertia for the move of Δ θ of the driving component part made at the step S3 shown in FIG. 18.

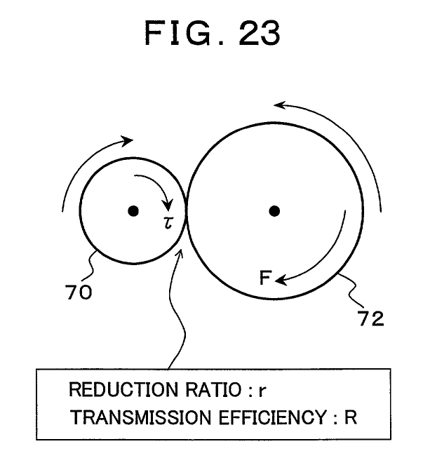

Next, equivalent static friction will be described. Like equivalent inertia, equivalent static friction means static friction of all driven joints viewed from the driving joints is looked at equivalently. By this, a minimum torque required for moving load caused by a combination of gears, etc. can be obtained, and this is similarly useful in selecting motors. Now, as shown in FIG. 23, assume that in front of a gear 70 having reduction ratio r and transmission efficiency R, there is a driven joint 72 comprising a gear having static friction torque F in front of a driving joint 70 as the gear of static friction torque F. When the torque of the driving joint 70 is supposed to be γ, and if static friction and force were in well balanced state, the relation

$$F = \frac{R τ}{r} \qquad ( 11 )$$

holds. By this,

$$τ = \frac{Fr}{R} \qquad ( 12 )$$

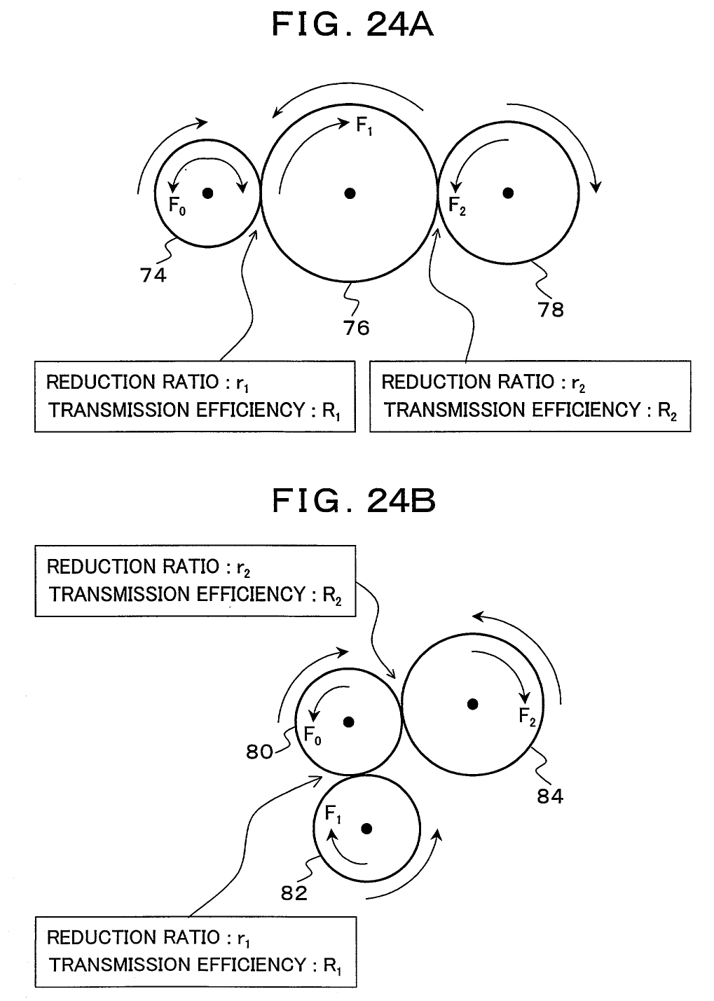

is an equivalent static friction of the driven joint 72 viewed from the driving joint axis. When driven relation is as shown in FIG. 24A, to the driving joint 74, driven joints are connected, such as driven joints 76, 78, and so, this driven relation can be expressed by

$$τ = {F}_{0} + \frac{{r}_{1}}{{R}_{1}} ( {F}_{1} + \frac{{r}_{2}}{{R}_{2}} {F}_{2} ) \qquad ( 13 )$$

in using of (12) recurrently. Also, as shown in FIG. 24B, to a driving joint 80, when the driven joints are branched off, like driven joints 82 and 84, this relation can be expressed by

$$τ = {F}_{0} + \frac{{F}_{1} {r}_{1}}{{R}_{1}} + \frac{{F}_{2} {r}_{2}}{{R}_{2}} \qquad ( 14 )$$

Wherein, Fn, Rn, and rn denote the static friction torque, transmission efficiency and reduction ratio of each joint noted in the drawing, respectively.

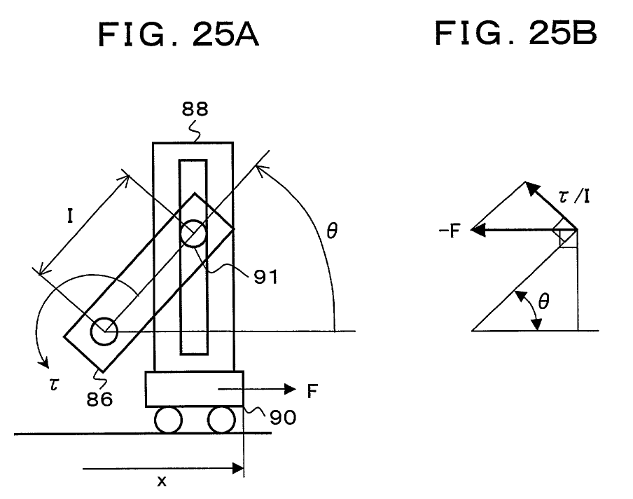

In the examples as described above, an example of embodiment is shown by gear relation, however, by the view that reduction ratio r is to be a ratio (Δø/Δθ) of the value Δø of the joint on the driven side moves when the joint on the driving side was moved, an embodiment can be made by the same calculation, even in terms of cam relation (including a groove). This is because in every mechanism, the product of force (torque) and amount of move is equal. Further, as to cam relation, no matter which one of the driving joint and driven joint is a rotational joint and the other is a translation joint, this relation holds by proper selection of the unit system. For example, the mechanism groove of the rotational joint 86 and translation joint 90 as shown in FIG. 25A is considered. Wherein, in the groove 88, the pin 91 of the rotational joint 86 slides. At this mechanism, F denotes friction force (unit: N) of the translation joint 90, γ denotes the drive torque (unit; Nm) of the rotational joint 86, and I denotes the distance (unit: n) from the axis of the rotational joint 88 to the meeting face of the pin 91 with the groove 88. And if driving is considered to be the translation joint 90 and driven is the rotational joint 86, the result is equal. In this case, as the relation x=l cos θ holds, reduction ratio r is as expressed by the equation

$$r = \frac{Δ x}{Δθ} = - l sin θ \qquad ( 15 )$$

While, as the meeting face of the pin 91 with the groove 88 is in a vertical direction, balance of force is in the relation as shown in FIG. 25B, and from this, the relation expressed by

$$F sin θ = - \frac{τ}{l} \qquad ( 16 )$$

holds. By this relation, l sin θ can be erased, and as the result of erase,

τ=Fτ (17)

is obtained. And when transmission efficiency R is considered, the result is the same as the equation (12).

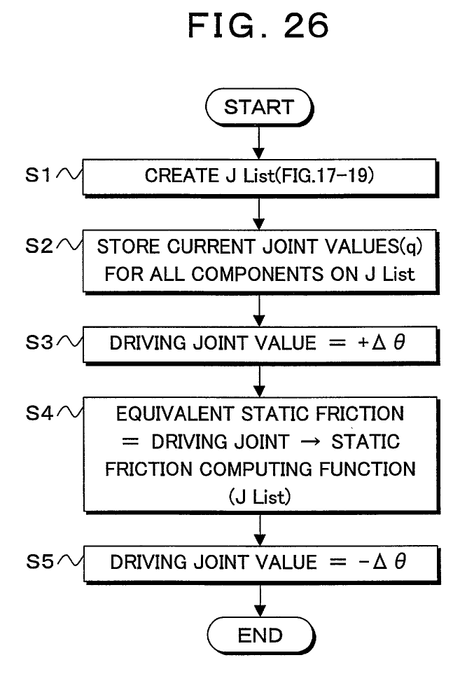

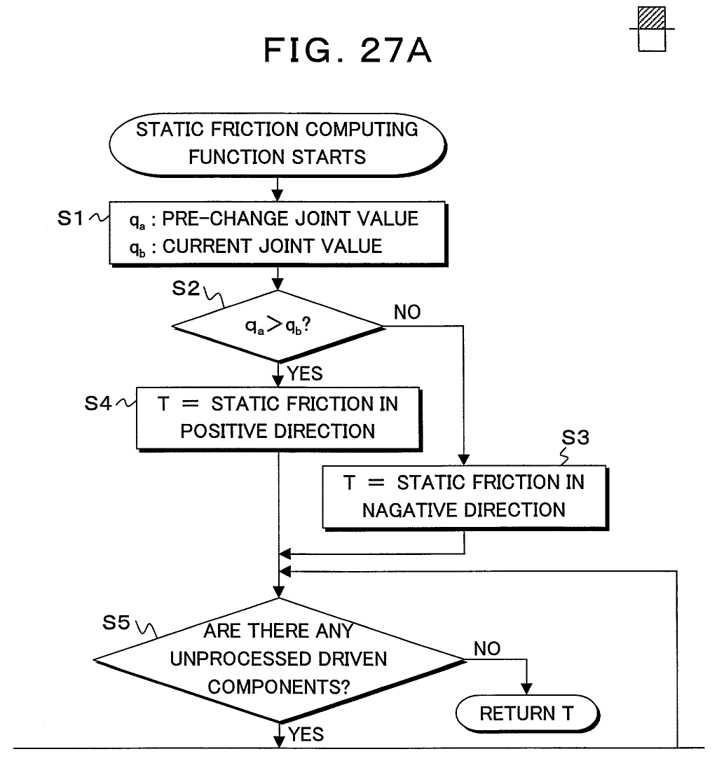

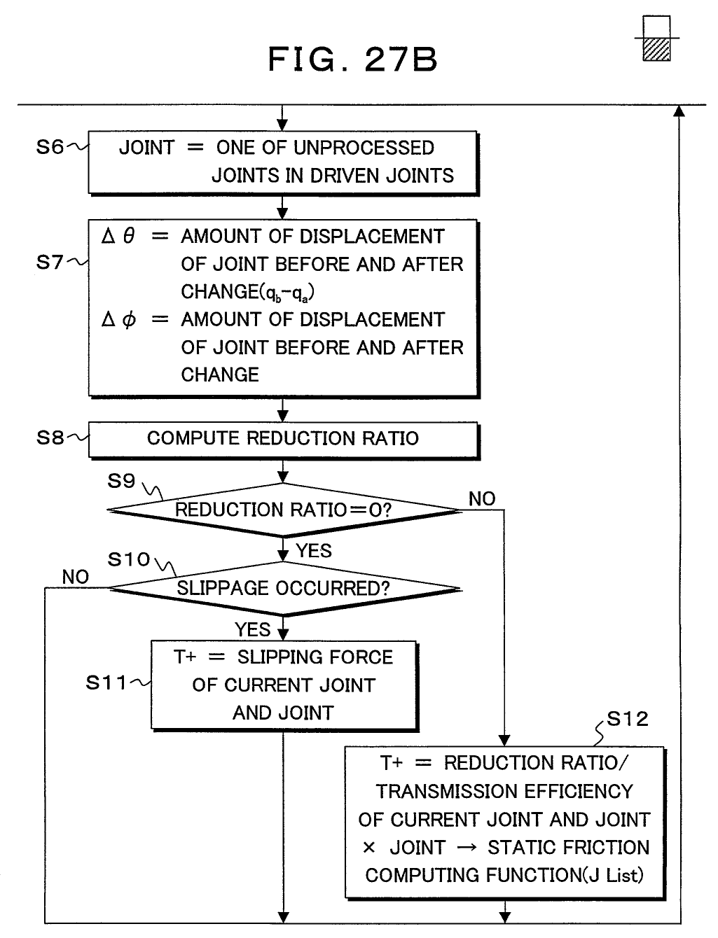

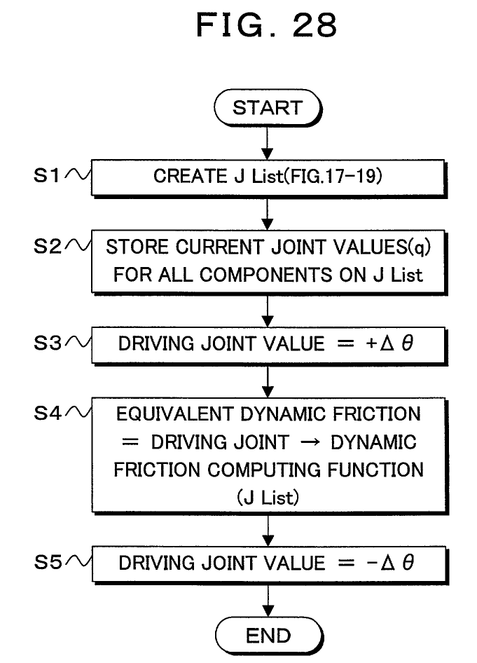

From the above, equivalent static friction of the mechanism can be found, following the algorithm given in the flowchart in FIG. 26. First, at the step S1, a J list of all the component parts of the driving joint is created. Process to create this component parts list is the same as the detailed process shown in FIGS. 17 through 19. Next, at the step S2, after the current joint value (q) is stored for all the component parts on the J List, at the step S3, the driving joint is moved only by Δθ. Then, at the step S4, static friction calculation function is called out to calculate equivalent static friction. The details of this static friction calculation function at the step S4 is as given in the flowcharts shown in FIGS. 27A and 27B. In this flowchart of static friction calculation function, after the joint value before change qa, and the current joint value qb are set at the step S1, the both values are compared at the step S2, and if the difference is a plus change, it means static friction in a positive direction of the step S4, and if a minus change, it means static friction in a negative direction of the step S3. And static friction calculation processing of the steps S6 through S12 will be repeated until the step S5 has no unprocessed driven component parts. By processing of this static friction calculation function, static friction (torque) is divided into positive torque and negative torque, for the purpose of simply expressing difference in the direction caused by a spring or gravity. Also as to slip, a friction force caused when slip occurs is set, and processing is made to add the set friction. Again back to FIG. 26, when equivalent static friction was calculated at the step S4, the driving joint is allowed to return to the reverted direction by Δθ, so as to return the driving joint to its initial state.

Next, equivalent dynamic friction will be described. Equivalent dynamic friction is applied to an extension of the same concept of equivalent inertia or equivalent static friction. In other words, K is considered to be equivalent dynamic frictions when angular speed of the driving joint is represented by ω a, and dynamic friction of all the driven joints is converted into the value around the axis of the driving joint and expressed in the form of

τ=Kωₐ (18)

Like in FIG. 23, when the case is considered in which there is one driven joint 72 having dynamic friction index k which is driven by the driving joint 70 which is a gear having transmission efficiency R, the equation

ω_{b}=rωₐ (19)

expressing the angular speed ωb of the driven joint 72 holds, from the definition of reduction ratio. In other words, dynamic friction torque generated at the driven joint axis will be expressed by

τ_{b}=Kω_{b}=Krωₐ (20)

When this torque is converted into the torque around the driving joint axis, the equation

$$τ = r \frac{{τ}_{b}}{R} = \frac{{Kr}^{2}}{R} {ω}_{a} \qquad ( 21 )$$

holds. From this, equivalent dynamic friction can be expressed by the equation

$$k = \frac{{Kr}^{2}}{R} \qquad ( 22 )$$

Moreover, like FIG. 24A, when to the driving joint 74, the driven joints 76 and 78 are connected, equivalent dynamic friction is calculated recurrently, like in calculation of equivalent static friction, resulting in the equation

$$k = {K}_{0} + \frac{{r}_{1}^{2}}{{R}_{1}} ( {K}_{1} + \frac{{r}_{2}^{2}}{{R}_{2}} {K}_{2} ) \qquad ( 23 )$$

Wherein, each of K0, K1 and K2 denotes coefficient of dynamic friction of the driving joint axis, coefficient dynamic friction of the driven joint axes at the first step, and at the second step, respectively, R1 and r1 denote coefficient of transmission and reduction ratio of the driving joint axis and the gear of the driven joint of the first step, and R2 and r2 denote coefficient of transmission and reduction ratio of the driven joints of the first step and the second step. Further as shown in FIG. 24B, when there is a plurality of driven joints, or as shown in FIGS. 25A and 25B, when one joint is a rotational joint and the other is a transition joint, the concept is the same as in the case of equivalent static friction.

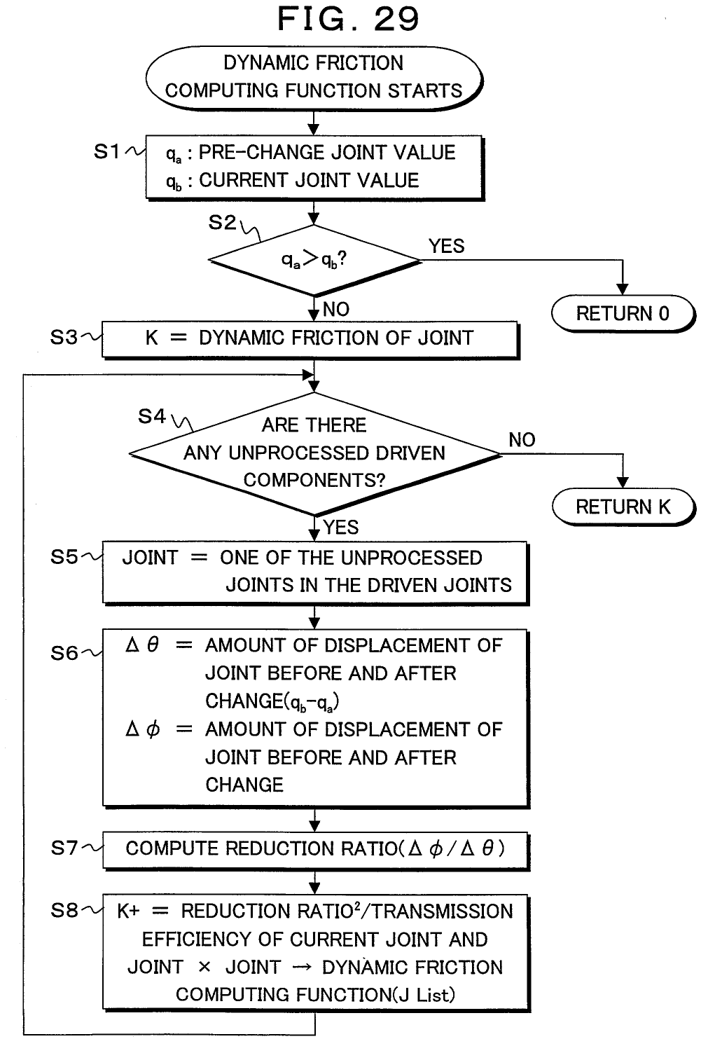

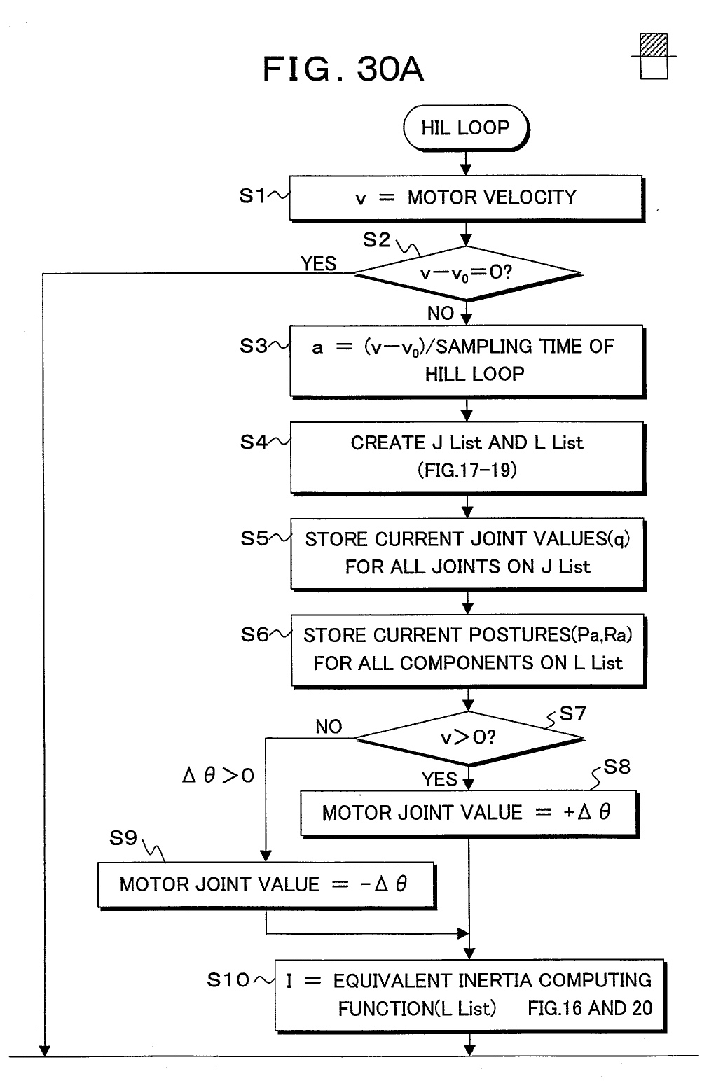

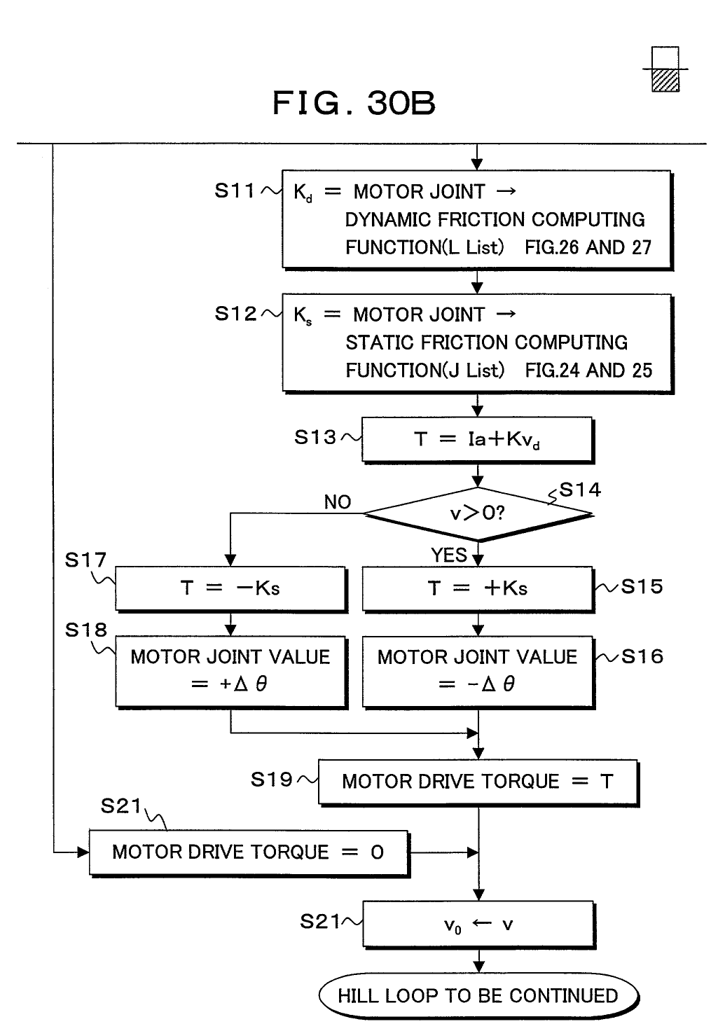

FIG. 28 shows a flowchart of algorithm to calculate equivalent dynamic friction, and FIG. 29 shows the detailed flowchart of dynamic friction calculation function of that step S4. Also at the calculation algorithm for equivalent dynamic friction shown in FIG. 28, after a component parts list J List for the driving joint is created at the step S1, at the step S2, the current joint value qt is stored for all component parts on the component parts list, and at the step S3, the driving joint is allowed to move by Δθ. Then, process goes on to the step S4, and processing of dynamic friction calculation function shown in FIG. 29 is executed. Finally at the step S5, the driving joint is allowed to move in the reverse direction by Δθ, to return to the initial state.

Next, description is made on calculation process of drive torque. A drive torque operation-processing unit 22 installed to the virtual mechanism model simulation device 14 shown in FIG. 2 can calculate and display the drive torque of the motor 26 in real time during simulation, using equivalent inertia, equivalent static friction and equivalent dynamic friction that are already explained. When the drive torque of the motor 26, which is the driving joint, is represented by γ, and displacement is represented by θ, kinetic equation of the three-dimensional mechanism model 25 can be expressed in the form of

$$τ = I \ddot{θ} + \frac{1}{2} \dot{I} \dot{θ} + {K}_{d} \dot{θ} + \{ \begin{matrix}+ {K}_{s} & ( \dot{θ} > 0 ) \\ + 0 & ( \dot{θ} = 0 ) \\ - {K}_{s} & ( \dot{θ} < 0 )\end{matrix} \qquad ( 24 )$$

Wherein, each of I, Kd and Ks denotes equivalent inertia of entire load, equivalent dynamic friction and equivalent static friction, respectively. Moreover, in the equation (24), when the second term of the equation is neglected, as the effect of it is generally small, the equation (24) can be rewritten as

$$τ = I \ddot{θ} + {K}_{d} \dot{θ} + \{ \begin{matrix}+ {K}_{s} & ( \dot{θ} > 0 ) \\ + 0 & ( \dot{θ} = 0 ) \\ - {K}_{s} & ( \dot{θ} < 0 )\end{matrix} \qquad ( 25 )$$

By solving of this equation (24) every simulation cycle, the load applied to the motor 26 can be calculated in real time.

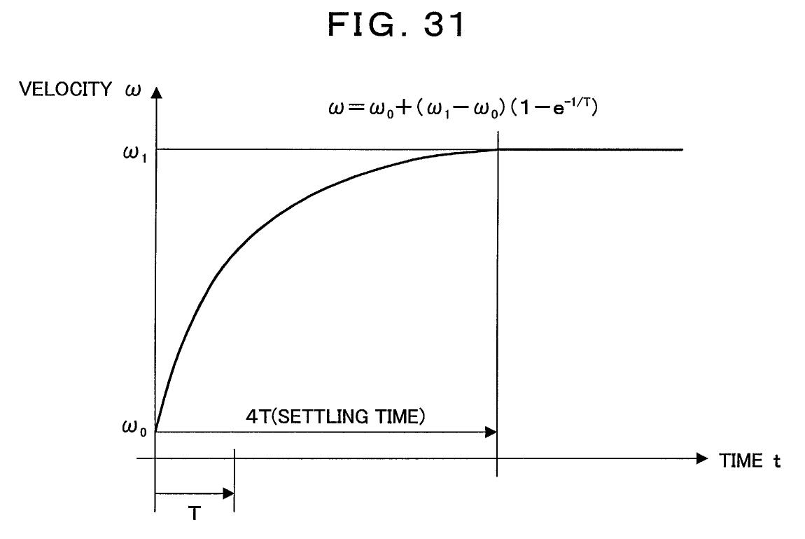

FIGS. 30A and 30B show flowcharts of algorithm for calculating drive torque. First, at the step S1, the motor velocity is calculated. The calculation of this motor velocity will be made clear in the description regarding FIG. 31. Next, if the change in the motor velocity is not 0, at the step S3, the change in the motor velocity is divided by the sampling time of simulation loop to find acceleration a. Then, at the step S4, component parts list J List and L List are created following the flowcharts shown in FIGS. 19 through 21. And at the step S5, after the current joint value (q) is stored for all the joints on the component parts list J List of the driving joint, at the step S6, the current posture (Pa, Ra) is stored for all the component parts on the component parts list L List of the driven joint. Following at the step S7, velocity is checked to see whether it is positive or negative value, and if the velocity is a positive value, at the step S8, the motor joint value is increased by Δθ. If the velocity is negative, at the step S9, the motor joint value is reduced by Δθ. Next, at the step S10, equivalent inertia calculation function is called out to find equivalent inertia. To be more specific, processes shown in FIGS. 18 and 22 are executed. Next, at the step S11, dynamic friction calculation function is called out and executed. To be more specific, processes shown in FIGS. 28 and 29 are executed. Further at the step S12, static friction calculation function is called out, to be more specific, processes shown in FIGS. 26, 27A and 27B are executed to calculate static friction. And at the step S13, the drive torque of the motor is calculated. After this step, at the step S14, the velocity is discriminated between positive and negative, and if positive, at the step S15, a positive figure is used for the equivalent static friction Ks to be used in torque calculation, and if negative, a minus figure is used for the equivalent static friction Ks to be used in torque calculation at the step S17. And at the steps S16 and S18, in the reverse order of the case of the steps S8 and S9, after the motor joint value is set to return the value to its initial state, at the step S19, the motor drive torque T is finally calculated, and at the step S10, the current motor velocity V is set to V=0 for the calculation to be made at the next time. Needless to say, if the velocity difference is 0 at the step S2, at the step S21, the motor drive torque is set to 0 to finish processing. The calculation processing of the motor drive torque as shown in FIGS. 30A and 30B is to be integrated as one processing in the virtual mechanism model simulation device 14 shown in FIGS. 4A and 4B. Under the present invention, as input/output or mechanism operation process is performed by the first processing unit as the highest priority processing, to the drive torque operation processing unit 22, process is to be assigned as a lower priority task. To be more specific, it is recommended to set the task by the drive torque operation processing unit 22 for the processing having the same priority as the task by the second processing unit 20 for drawing having lower priority.

FIG. 31 describes the motor velocity calculation process at the step S1 in FIG. 30A. This drawing shows the characteristic of the initial change in the rotation velocity ω of the motor, when the motor is regarded as a primary delay series. The motor velocity at the time t, when the motor is regarded as a primary delay series, can be expressed by

ω=ω₀+(ωᵢ−ω₀)(1−e^{-1/T})

Here, ωᵢ denotes target velocity, ω₀ denotes the motor velocity before target velocity command and T is a constant which is proportional to the settling time 4T showing the nature of the motor.

Next, on the simulation system under the present invention, a torque motor can be embodied using of equivalent inertia, equivalent dynamic friction, and equivalent static friction computed regarding a virtual mechanism model. This torque motor can be embodied by allowing of the motor to obtain the target torque instead of obtaining the target velocity, while the motor used to obtain the target velocity of the motor from a group of input bits to be the motor velocity signal E1 sent from the built-in software execution device 10, to calculate the move of the motor. Then, the method to find the travel amount of the motor Δθ in simulation cycles obtained from the group of input bits will be described. Now, when the motor velocity ω is ω₀, the target torque γ is supposed to be applied to the motor. When the applied torque is expressed by

$${τ}_{o} = τ - \{ \begin{matrix}+ {K}_{s} & ( {ω}_{o} > 0 ) \\ + 0 & ( {ω}_{o} = 0 ) \\ - {K}_{s} & ( {ω}_{o} < 0 )\end{matrix} \qquad ( 26 )$$

equation

τ₀=I\dot{ω}+K_{d}ω (27)

is obtained from the equation (24). When this equation is solved, this yields equation

$$ω = {ω}_{o} + ( \frac{{τ}_{o}}{{K}_{d}} - {ω}_{o} ) ( 1 - {ⅇ}^{- \frac{{K}_{d} t}{I}} ) \qquad ( 28 )$$

From this, when the motor velocity is ωk−1 in the total simulation cycles, the motor travel amount Δθ during the sampling interval Δt can be expressed by

$$Δθ = {ω}_{k} Δ t = Δ t \{ {ω}_{k - 1} + ( \frac{{τ}_{o}}{{K}_{d}} - {ω}_{k - 1} ) ( 1 - {ⅇ}^{- \frac{{K}_{d} Δ t}{I}} ) \} \qquad ( 29 )$$

Wherein, τ0 denotes the value obtained by subtracting static friction torque from the target torque. From this, upon simulation processing under the present invention, a torque motor can be embodied by the execution of algorithm complying with the following procedures:

(1) to find the target motor torque from a group of input bits sent from the built-in software execution device 10;

(2) to find equivalent inertia, equivalent dynamic friction and equivalent static friction;

(3) to find displacement amount Δθ of the motor from the equation (29), and update the displacement amount of the motor; and

(4) to store the motor velocity for the purpose of a series of calculations to be performed next time.

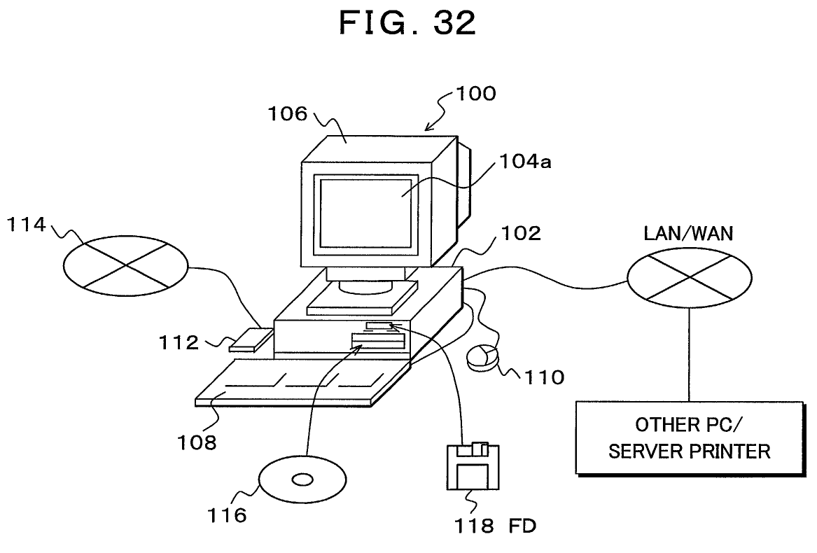

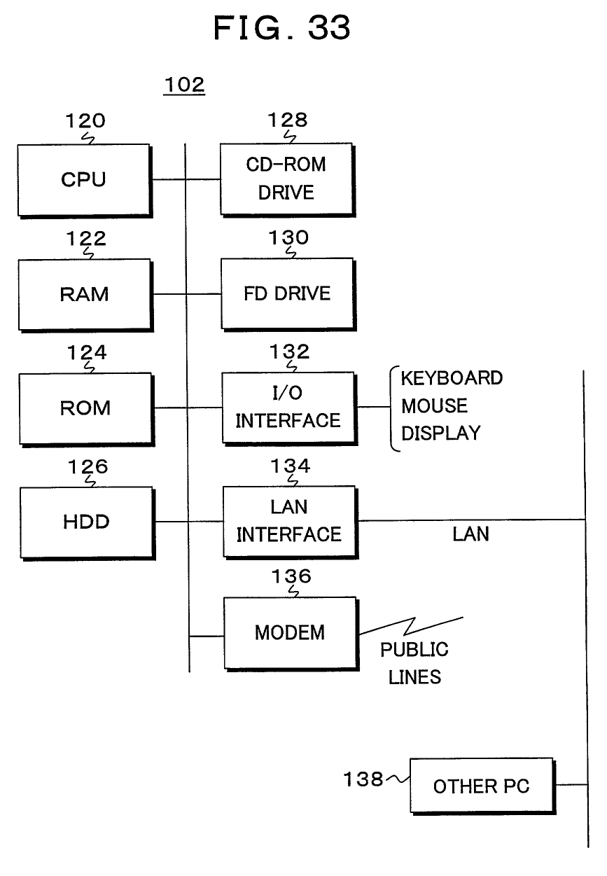

Next, description will be made on an embodiment of a record medium that is able to read a computer storing a simulation program to be executed by the virtual mechanism model simulation device 14 shown in FIGS. 4A and 4B. The computer system 100 shown in FIG. 32 is a system to execute the simulation program under the present invention, having a main body 102, and including CPU120, RAM122, ROM124, disk drive device HDD126, CD-ROM drive 128, FD drive 130, keyboard, mouse, I/O interface to connect display, LAN interface 134, modem 136, etc. being embedded in the main body 102. The computer system is further equipped with a display 106 to display information including image on a display screen 104a by the instruction from the main body 102, keyboard 108 to enter a variety of information pieces to the computer system 100, mouse 110 to specify an optional position on the display screen 104a of the display 106, LAN interface 134 to get access to the database connected with a communication line and modem 136. The simulation program under the present invention is stored on the database connected with a communications line, further on the database of another computer system, by using of transportable record media, like CD-ROM, floppy disk, DVD disk, optical disk, IC card, etc., and after installed to the computer system 100, this simulation program will be executed by the computer system 100.

Wherein, the record media includes the database that holds the program through a communications line, or other computer system and its database, and further on-line transfer media, in addition to transportable record media, like CD-ROM 116, floppy disk (FD) 118, DVD disk, optical disk, IC card, etc., and record device like hard disk HDD installed to the inside or outside of the computer system 100.

As set forth hereinabove, according to the present invention, simulation process is divided into a high-speed, low-loading process, such as input of motor command value, mechanism operation and output of sensor value, and a low-speed, high-loading process, such as position/posture calculation of component parts or drawing on the screen, and by means of programming of the high-speed, low-loading process to be executed at high speed in the same periodicity as the cycle of the control program installed to the built-in software execution device, and while as to the low-speed, high-loading process, like drawing process to be thinned and executed like one time per several times, for the purpose of eliminating the necessity of synchronous process for matching time between the software execution device and the simulation device, so that real time simulation of a virtual mechanism model can be embodied, and further a control program using the virtual mechanism model can be efficiently designed and developed.

As to an actuator of the motor of a virtual mechanism model, as equivalent inertia, equivalent static friction, equivalent dynamic friction, and further drive torque are calculated in real time and displayed, design work including selection of a motor for a mechanism model can be performed more properly.

As a result of synchronous process being unnecessary, simulation by pulse input at a stepping motor can be implemented.

The present invention is not limited to the above embodiments, but may cover any proper variants of the embodiments without impairing its objects and advantages. The present invention is not restricted by the numerical values indicated in the above embodiments.

What is claimed is:

1. A simulation system comprising:
a built-in software execution device which executes a control program to control a mechanism device; and
a simulation device which constructs a virtual mechanism model of said mechanism device, said simulation device allowing said virtual mechanism model to run by simulation calculations which depend on input data from said built-in software execution device;
said simulation device including:
a first processing unit which executes a first processing on input/output to/from said built-in software execution device and on mechanism operations of said virtual mechanism model; and
a second processing unit which executes a second processing on a user interface including drawing of said virtual mechanism model, using a free time of said first processing unit.

2. The system according to claim 1, wherein
said simulation device includes two processors so that said first processing unit and said second processing unit are separately implemented so as to execute in parallel said input/output and mechanism operations by said first processing unit and said drawing processing by said second processing.

3. The system according to claim 1, wherein
said first processing unit and said second processing unit are implemented in multitasking on said processors of said simulation device, said input/output and mechanism operations by said first processing unit being executed in a short cycle with a higher priority given to the task, said drawing processing by said second processing unit being executed in a long cycle with a lower priority given to the task.

4. The system according to claim 3, wherein
said system allows said processing of said first processing unit to be executed in a given cycle by synchronizing with a timer counter.

5. The system according to claim 1, wherein
said mechanism device includes a motor which uses a pulsed signal or a sinusoidal wave signal as its input, said simulation device allowing said virtual mechanism model to run by receiving a pulsed signal or sinusoidal wave signal to the motor, in the form of a motor command from said built-in software execution device.

6. The system according to claim 1, wherein
said second processing unit executes said drawing processing for moving parts of said virtual mechanism model.

7. The system according to claim 1, wherein
said simulation device further includes a third processing unit which converts, for display, at least one of equivalent inertia, equivalent static friction and equivalent dynamic friction of the total load applied to an axis that is optionally selected from the relation of a predefined driving mechanism, into a value viewed from said selected axis.

8. The system according to claim 7, wherein
said simulation device further includes a third processing unit which calculates and displays, in real time, a motor drive torque required for action, using equivalent inertia, equivalent static friction and equivalent dynamic friction of the total load, viewed from a motor drive shaft, applied to an axis which is optionally selected based on the relation of a predefined drive mechanism.

9. The system according to claim 8, wherein
said simulation device implements a torque motor for input data from said built-in software execution device, to thereby allow said virtual mechanism model to run.

10. The system according to claim 9, wherein
at every predetermined simulation cycle, said simulation device repeats processings which include:
finding a target torque of a torque motor from command input data of said built-in software execution device;
finding equivalent inertia, equivalent static friction and equivalent dynamic friction of the total load, viewed from a drive shaft of said torque motor; and
finding the amount of displacement of said motor, from the obtained target torque, equivalent inertia, equivalent static friction and equivalent dynamic friction, so as to update the displacement of said motor.

11. The system according to claim 1, wherein
said simulation device stores input data from said built-in software execution device during simulation, together with time data, said simulation device replaying simulation again, using the stored data, after simulation.

12. A simulation method which constructs a virtual mechanism model of a mechanism device and which allows said virtual mechanism model to run by means of simulation calculations which depend on input data from a built-in software execution device, said method comprising:
a first processing step which includes executing a first processing on input/output to/from said built-in software execution device and on mechanism operations of said virtual mechanism model; and
a second processing step which includes executing a second processing on a user interface including drawing of said virtual mechanism model, by use of a free time of said first processing step.

13. The method according to claim 12, wherein
said simulation device includes two processors so as to execute in parallel said input/output and mechanism operations by said first processing step, and said drawing processing by said second processing step.

14. The method according to claim 12, wherein
said first processing step and said second processing step are implemented in multitasking on said processors of said simulation device, said input /output and mechanism operations by said first processing step being executed in a short cycle with a higher priority given to the task, said drawing processing by said second processing step being executed in a long cycle with a lower priority given to the task.

15. The method according to claim 12, wherein
said processing of said first processing step is executed in a given cycle by synchronizing with a timer counter.

16. The method according to claim 12, wherein
said mechanism device includes a motor which uses a pulsed signal or a sinusoidal wave signal as its input, said simulation device allowing said virtual mechanism model to run by receiving a pulsed signal or sinusoidal wave signal to the motor, in the form of a motor command from said built-in software execution device.

17. The method according to claim 12, wherein
said second processing step includes executing said drawing processing for moving parts of said virtual mechanism model.

18. The method according to claim 12, further comprising:
a third processing unit which includes converting, for display, at least one of equivalent inertia, equivalent static friction and equivalent dynamic friction of the total load applied to an axis that is optionally selected from the relation of a predefined driving mechanism, into a value viewed from said selected axis.

19. The method according to claim 12, further comprising:
a third processing step which includes calculating and displaying, in real time, a motor drive torque required for action, by use of equivalent inertia, equivalent static friction and equivalent dynamic friction of the total load, viewed from a motor drive shaft.

20. The method according to claim 19, wherein
a torque motor is implemented for input data from said built-in software execution device, to thereby allow said virtual mechanism model to run.

21. The method according to claim 20, wherein
at every predetermined simulation cycle, said simulation device repeats processings which include:
finding a target torque of a torque motor from command input data of said built-in software execution device;
finding equivalent inertia, equivalent static friction and equivalent dynamic friction of the total load, viewed from a drive shaft of said torque motor; and
finding the amount of displacement of said motor, from the obtained target torque, equivalent inertia, equivalent static friction and equivalent dynamic friction, so as to update the displacement of said motor.

22. The method according to claim 12, wherein
said simulation device stores input data from said built-in software execution device during simulation, together with time data, said simulation device replaying simulation again, using the stored data, after simulation.

23. A program allowing a computer to execute:
a first processing step which includes executing a first processing on input/output to/from said built-in software execution device and on mechanism operations of said virtual mechanism model; and
a second processing step which includes executing a second processing on a user interface including drawing of said virtual mechanism model, by use of a free time of said first processing step.

24. The program according to claim 23, wherein
said program allows two computers to execute, in parallel, said input/output and mechanism operations by said first processing step, and said drawing processing by said second processing step.

25. The program according to claim 23, wherein
said program allows said computer to implement said first processing step and said second processing step in multitasking on said computer processors of said simulation device, so that said input/output and mechanism operations by said first processing step are executed in a short cycle with a higher priority given to the task, and that said drawing processing by said second processing step is executed in a long cycle with a lower priority given to the task.

26. The program according to claim 25, wherein
said program allows said processing of said first processing step to be executed in a given cycle by synchronizing with a timer counter.

27. The program according to claim 23, wherein
said program allows said virtual mechanism model to run by feeding a pulsed signal or a sinusoidal wave signal in the form of a motor command from said built-in software execution device, to a motor which uses said pulsed signal or sinusoidal wave as its input.

28. The program according to claim 23, wherein
said program allows said drawing processing in said second processing step to be executed for moving parts of said virtual mechanism model.

29. The program according to claim 23, wherein
said program further allows said computer to execute a third processing step which includes converting, for display, at least one of equivalent inertia, equivalent static friction and equivalent dynamic friction of the total load applied to an axis that is optionally selected from the relation of a predefined driving mechanism, into a value viewed from said selected axis.

30. The program according to claim 29, wherein
said program further allows said computer to execute a third processing step which includes calculating and displaying, in real time, a motor drive torque required for action, by use of equivalent inertia, equivalent static friction and equivalent dynamic friction of the total load, viewed from a motor drive shaft.

31. The program according to claim 30, wherein
said program allows said virtual mechanism model to run by implementing a torque motor for input data from said built-in software execution device.

32. The program according to claim 31, wherein
at every predetermined simulation cycle, said program allows said computer to repeat processings which include:
finding a target torque of a torque motor from command input data of said built-in software execution device;
finding equivalent inertia, equivalent static friction and equivalent dynamic friction of the total load, viewed from a drive shaft of said torque motor; and
finding the amount of displacement of said motor, from the obtained target torque, equivalent inertia, equivalent static friction and equivalent dynamic friction, so as to update the displacement of said motor.

33. The program according to claim 31, wherein
said program allows said computer to store input data from said built-in software execution device during simulation, together with time data and replay simulation again, using the stored data, after simulation.

34. A program allowing a computer to execute:
a step which includes executing processing on input/output to/from a built-in software execution device, and on mechanism operations of a virtual mechanism model, and on a user interface including drawing of said virtual mechanism model; and
a step which includes converting and displaying in real time at least one of equivalent inertia, equivalent static friction and equivalent dynamic friction of the total load applied to an axis which is optionally selected, from the relation of a predefined drive mechanism, into a value viewed from the selected axis, said step including calculating and displaying in real time a motor drive torque required for action, by use of the obtained equivalent inertia, equivalent static friction and equivalent dynamic friction.

35. A computer readable record medium having a program stored therein, said program allowing said computer to execute:
a first processing step which includes executing a first processing on input/output to/from a built-in software execution device, and on mechanism operations of a virtual mechanism model; and
a second processing step which includes executing a second processing on a user interface including drawing of said virtual mechanism model, by use of a free time of said first processing step.
